(19) United States
(12) Patent Application Publication
(10) Pub. No.: US 2015/0128866 A1
(43) Pub. Date: May 14, 2015

(54) RUGGED AUTOMATED TRAINING SYSTEM AND METHODS

(71) Applicant: Coherent Technical Services, Inc., Lexington Park, MD (US)

(72) Inventors: Patrick A. Madorin, Leonardtown, MD (US); Kevin P. Myers, Lewisburg, PA (US); Joseph V. Tranquillo, Lewisburg, PA (US)

(21) Appl. No.: 14/402,026

(22) PCT Filed: Jun. 6, 2013
(86) PCT No.: PCT/US2013/044549

§ 371 Date: Nov. 18, 2014

Related U.S. Application Data
(60) Provisional application No. 61/656,282, filed on Jun. 6, 2012.

(51) Int. Cl. A01K 15/02; A01K 27/00; A01K 5/02

(52) U.S. Cl. CPC A01K 15/02; A01K 5/02; A01K 27/002
USPC 119/51.01; 119/720; 119/719; 119/712

(57) ABSTRACT

Systems, kits, and methods for training animals. The system can include an animal training enclosure, an animal harness assembly, and a system controller assembly. The animal training enclosure can include a housing in which the animal to be trained is positioned, a stimuli delivery assembly that presents stimuli and distracters to the animal, and a primary reinforcement apparatus. The animal harness assembly can include a harness mounted on the animal, the harness housing a vibrotactile apparatus that can be used as a secondary reinforcement apparatus, an electronic compass that can measure orientation of the animal, and a wireless interface for communicating with the system controller assembly. The methods can include a method of training an animal using a secondary reinforcement positioned on a harness mounted on the animal, a method of concurrently training a plurality of animals, a method of detecting an unexploded landmine, and a method of demining a minefield.

### BACKGROUND OF THE INVENTION

1. The Field of the Invention

The present invention generally relates to systems and methods for training small animals. In particular, embodiments relate to systems and methods used to train small animals indigenous to an area to detect buried explosives or other compounds of interest in the area.

2. The Related Technology

Post-conflict landmines cause thousands of civilian injuries and casualties each year throughout much of Africa, the Middle East, Southeast Asia and South America. In addition, these explosive remnants of war make vast tracts of land unusable where land resources are needed by the local population. Millions of landmines have been left where minimal or no resources for demining exist. Demining benefits affected communities both by saving lives and freeing land for use.

Conventional methods of demining for humanitarian missions are performed with metal detectors, mechanical prodders, armored vehicles, and/or dogs. Some newer humanitarian detection methods involve using biological methods such as bacteria, plants, small mammals, and honey bees to detect the explosives contained within the landmines.

Each of these methods has pros and cons, but none provides a complete solution when considering cost, logistics, removal thoroughness, inadvertent explosions, and false detections. For example, when using animals, such as dogs, to detect the explosives, the animals must first be trained to detect the explosive and indicate where the explosive has been detected. This is done by an expert in animal training over an extended period of time using expensive lab equipment. Once the animals have been trained, the training expert, or one of his colleagues who has been suitably educated, must travel with the animals to the destination, where the animals are deployed to detect the explosives, e.g., in a minefield. With all of the training and expertise required, along with the required travelling, this process can be very expensive. In addition, only a fraction of the minefields around the world can be demined because of the limited number of experts and systems available.

A new approach has been developed in the last couple of years in which rats are trained to detect mines using their keen sense of smell. Specifically, rats can be trained to signal when a particular smell associated with a landmine is detected. The rats are trained by experts using known techniques of food and click training and then accompanied by the expert trainers to the portion of the world where the landmines are located. Similar to approaches with dogs, the rats are then used by the expert trainers to detect landmines. Although this may be an improvement over earlier approaches, it still suffers from many of the same shortcomings. For example, the expert trainer must accompany the animal to the destination, and only a fraction of the minefields around the world can be demined because of the limited number of experts and systems available.

It would be beneficial in the art to have systems and/or methods that can solve one or more of the problems discussed above.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF SOME EXAMPLE EMBODIMENTS

In general, example embodiments relate to systems and methods for training small animals. In particular, embodiments relate to portable systems and methods that can be sent to an area and used there to train small animals indigenous to the area to detect buried explosives or other compounds of interest in the area.

In one embodiment, a system for training animals can include an animal training enclosure, an animal harness assembly, and a system controller assembly. The animal training enclosure can include a housing bounding a training chamber, the housing including a floor having a plurality of ports that communicate with the training chamber, a stimuli delivery assembly disposed below the floor, and a primary reinforcement apparatus that communicates with the training chamber so as to selectively provide a primary animal reinforcement to the training chamber. The stimuli delivery assembly can include a positioner that is movable between a first position, in which a predetermined portion of the positioner is aligned with a first one of the ports, and a second position, in which the predetermined portion of the positioner is aligned with a second one of the ports, an actuator that moves the positioner between the first and second positions, and a container configured to be filled with a material that provides a stimulus, the container being securable on the predetermined portion of the positioner such that the container is aligned with the first and second ports, respectively, when the positioner is positioned in the first and second positions. The animal harness assembly can be configured to be mounted on an animal so as to monitor the actions of the animal when the animal is positioned within the training chamber. The system controller assembly can electronically communicate with the animal training enclosure and the animal harness assembly.

In one embodiment, a system for training animals can include a plurality of animal training enclosures, a plurality of animal harness assemblies, and a system controller assembly. Each animal training enclosure can include a housing bounding a training chamber, the housing including a floor having a plurality of ports that communicate with the training chamber, a stimuli delivery assembly disposed below the floor, and a primary reinforcement apparatus that communicates with the training chamber so as to selectively provide a primary animal reinforcement to the training chamber. The stimuli delivery assembly can include a positioner that is movable between a first position, in which a predetermined portion of the positioner is aligned with a first one of the ports, and a second position, in which the predetermined portion of the positioner is aligned with a second one of the ports, an actuator that moves the positioner between the first and second positions, and a container configured to be filled with a material that provides a stimulus, the container being securable on the predetermined portion of the positioner such that the container is aligned with the first and second ports, respectively, when the positioner is positioned in the first and second positions. Each animal harness assembly can be configured to be mounted on an animal so as to monitor the actions of the animal when the animal is positioned within one of the training chambers. The system controller assembly can electronically communicate with the animal training enclosures and the animal harness assemblies.

In one embodiment, a kit for training animals can include an animal training enclosure, a plurality of containers, a plurality of animal harness assemblies, and a system controller assembly. The animal training enclosure can include a housing bounding a training chamber, the housing including a floor having a plurality of ports that communicate with the training chamber, a stimuli delivery assembly disposed below the floor, and a primary reinforcement apparatus that communicates with the training chamber so as to selectively provide a primary animal reinforcement to the training chamber. The stimuli delivery assembly can include a positioner having a plurality of container ports, each container port being positioned on the positioner so as to align with each of the floor ports as the positioner is moved, and an actuator that moves the positioner. Each of the plurality of containers can be configured to be filled with a material that provides an odor stimulus that can include a target odor, a distracter odor, or a combination of both, each container being receivable within any of the container ports of the positioner such that different combinations of containers can be used for different training sessions. Each animal harness assembly can be configured to be mounted on an animal so as to monitor the actions of the animal when the animal is positioned the training chamber. The system controller assembly can electronically communicate with the animal training enclosure and the animal harness assemblies so as to monitor animals and control training when the animals are within the training chamber.

In one embodiment, a method of training an animal can include determining when an animal exhibits a specific behavior in response to a predetermined stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on a harness mounted on the animal.

In one embodiment, a method of concurrently training a plurality of animals can include placing a plurality of animals in a plurality of animal training enclosures, a separate animal being placed in each training enclosure; and concurrently for each animal: monitoring the activity of the animal in the corresponding animal training enclosure; determining when the animal exhibits a specific behavior in response to a predetermined stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on a harness mounted on the animal.

In one embodiment, a method of demining a minefield can include receiving an animal training kit; obtaining an animal indigenous to the minefield area; training the animal, using the animal training kit, to exhibit a specific behavior when a stimulus indicative of a mine has been detected; and placing the trained animal in the minefield and determining a location of an unexploded mine by detecting when the animal performs the specific behavior. The kit can include an animal training enclosure, a plurality of containers, a plurality of animal harness assemblies, and a system controller assembly. The animal training enclosure can include a housing bounding a training chamber, the housing including a floor having a plurality of ports that communicate with the training chamber, a stimuli delivery assembly disposed below the floor, and a primary reinforcement apparatus that communicates with the training chamber so as to selectively provide a primary animal reinforcement to the training chamber. The stimuli delivery assembly can include a positioner having a plurality of container ports, each container port being positioned on the positioner so as to align with each of the floor ports as the positioner is moved, and an actuator that moves the positioner. Each of the plurality of containers can be configured to be filled with a material that provides an odor stimulus that can include a target odor, a distracter odor, or a combination of both, each container being receivable within any of the container ports of the positioner such that different combinations of containers can be used for different training sessions. Each animal harness assembly can be configured to be mounted on an animal so as to monitor the actions of the animal when the animal is positioned the training chamber. The system controller assembly can electronically communicate with the animal training enclosure and the animal harness assemblies so as to monitor the animal and control training when the animal is within the training chamber

Additional features of the invention will be set forth in the description which follows, and in part will be obvious from the description, or may be learned by the practice of the invention. The features of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) to refer to a specific instance of the element.

FIG. 1 is a high-level block diagram of an embodiment of the Ruggedized Automated Training System (“RAT System”);

FIG. 2 is a block diagram illustrating the system architecture of an embodiment of the RAT System;

FIG. 3 is a block diagram of an embodiment of an animal training enclosure;

FIG. 4 is a perspective view of an embodiment of an animal training enclosure;

FIG. 5 is an exploded perspective view of the animal training enclosure shown in FIG. 4;

FIG. 6 is a perspective view of a stimuli delivery assembly according to one embodiment;

FIGS. 7A and 7B are perspective views of embodiments of stimuli containers that can be used in the stimuli delivery assembly shown in FIG. 6;

FIG. 8 is a perspective view of a food dispenser assembly used in one embodiment as the primary reinforcement apparatus;

FIG. 9 is a block diagram illustrating an I/O functional design according to one embodiment;

FIG. 10 is a block diagram of an embodiment of an animal harness assembly;

FIG. 11 is a top view of an embodiment of an orientation detector;

FIG. 12 is a top view of an embodiment of an secondary reinforcer;

FIG. 13 is a top view of an embodiment of a wireless interface;

FIG. 14 is an image of an embodiment of an animal harness being worn by an animal during testing;

FIG. 15 is a front view of an embodiment of a system controller assembly;

FIG. 16 is a perspective view of an embodiment of a system controller;

FIG. 17 is a front view of an embodiment of a user interface assembly;

FIG. 18 is a perspective view of an embodiment of an external power interface panel;

FIG. 19 is a perspective view of an embodiment of an animal training enclosure interface panel;

FIG. 20 is a perspective view of an embodiment of a communications interface panel;

FIG. 21 is a perspective view of an embodiment of an power conversion panel;

FIG. 22 is a block diagram of a functional power design of the system controller assembly, according to one embodiment;

FIG. 23 is a perspective view of an embodiment of a system I/O panel;

FIG. 24 is a perspective view of an embodiment of a battery module;

FIG. 25 is a perspective view of an embodiment of a system controller assembly housing;

FIG. 26 is a functional block diagram showing how various components of the animal training enclosure, the animal harness, and the system controller assembly can work together according to one embodiment;

FIG. 27 is a block diagram of an embodiment having four animal training enclosures;

FIG. 28 depicts a method for controlled delivery of odor stimuli to the training chamber according to one embodiment;

FIG. 29 shows a method of training an animal according to one embodiment;

FIG. 30 shows a training progression sequence that can be performed to train an animal for successful demining operations according to one embodiment;

FIG. 31 depicts steps performed during behavior shaping training according to one embodiment;

FIG. 32 depicts steps performed during discrimination training according to one embodiment; and

FIGS. 33-40 depict various GUI windows used to guide a trainer through a training session according to one embodiment.

### DETAILED DESCRIPTION

The present invention relates to a Ruggedized Automated Training System (“RAT System”) used to train small animals for detecting landmines, among other things, using the animal's sense of smell. The RAT System includes systems, apparatuses, and methods of use according to the various embodiments discussed and envisioned herein.

The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Detailed description of well-known devices and processes have been excluded so as not to obscure the discussion in details that would be known to one of ordinary skill in the art.

As used in the specification and appended claims, directional terms, such as “top,” “bottom,” “up,” “down,” “upper,” “lower,” “proximal,” “distal,” and the like are used herein solely to indicate relative directions and are not otherwise intended to limit the scope of the invention or the claims.

Various benefits over the art can be realized by embodiments of the present invention. Some examples include:
animals can be trained to detect landmines by non-experts;
once trained, the animals can be used to detect landmines by non-experts;
animals can be trained at the landmine site;
animals indigenous to a landmine area can be used;
training kits can be shipped quickly to anywhere in the world they are needed, unaccompanied by an expert;
the training kits can be ruggedized for use anywhere in the world; and
multiple animals can be trained concurrently using a single electronic system controller.

The above list of benefits is by no means exhaustive. Other benefits can also be realized and will become known by use of the various embodiments.

In developing embodiments of the invention, various goals were kept in mind. Some of those goals included:
to develop a ruggedized apparatus and corresponding methods that accurately and reliably train a wide variety of animal species to locate landmines and other items;
to make the apparatus and methods easy for a non-expert operator to use and as idiot-proof as possible;
to allow for concurrent training of multiple animals using a single apparatus;
to make the apparatus inexpensive and relatively easy to ship to third-world countries;
to allow for future growth capability; and
to make the training of animals highly efficient.

Among other inventive features, various embodiments of the invention incorporate two features that have never been used before in the training of small animals. First, the use of a vibrotactile device as a secondary reinforcer. Second, the use of an electronic compass to automatically detect that an animal performs a particular motion or exhibits a particular action when the animal has detected a target odor. Both of these inventive features are discussed in detail below. Of course, these are just two inventive features; other inventive features are also found in the apparatus and method embodiments described and envisioned herein.

During the development and testing of the RAT System, various candidate animals were identified. The ideal animals include small animals that weigh less than 7 kg and score well on the following discriminators: olfactory acuity, learning and memory capabilities, responsiveness to food rewards, hardiness and fecundity, tameness, and resistance to zoonotic diseases. Of course, while the above qualities are desired in the candidate animals, they are not required. Other animals that do not possess some or all of the above qualities can also be used.

Using the above qualities as a guide, four types of animals have been identified as being particularly ideal for use with the RAT System. These include the Norway rat, the domestic ferret, the small Asian mongoose, and the giant African pouched rat. The largest species if this group is the giant African pouched rat, which weighs in at about 2.4 kg. The animals in this group of species can be found throughout the portions of the world that have landmines so as to provide adequate geographic region coverage. Use of native species in various geographic locations increases the flexibility of the RAT System for use in the field. In one embodiment, any rodent can be used as the target animal.

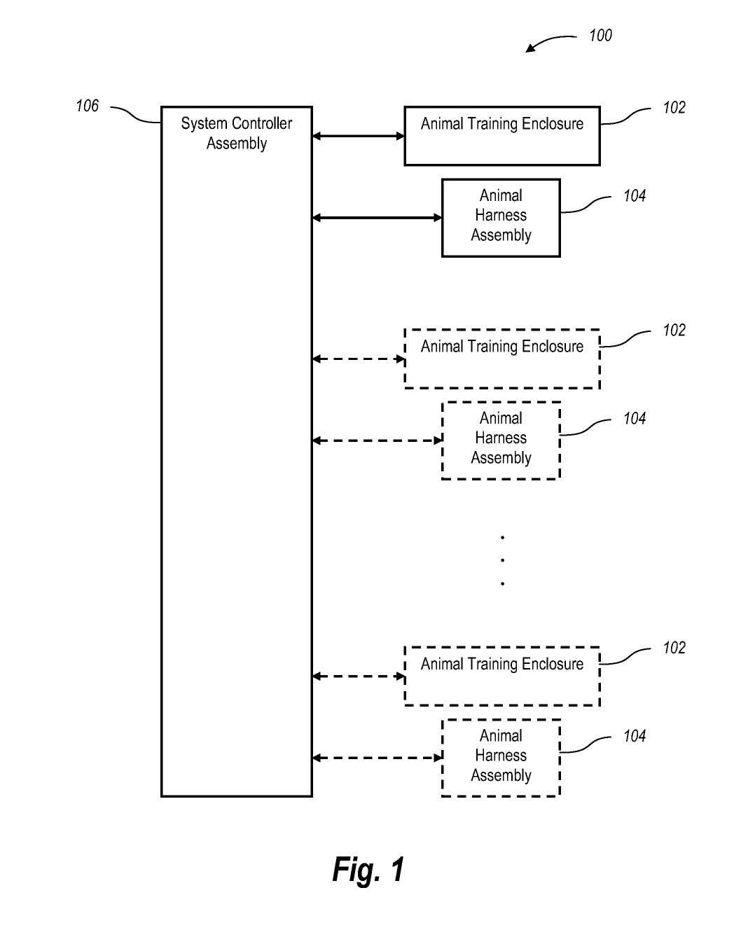

One embodiment of the RAT system 100 is depicted in FIG. 1. As depicted, the RAT System 100 can comprise one or more animal training enclosures 102, one or more animal harness assemblies 104, and a system controller assembly 106. The animal training enclosure may also be referred to herein as an animal training bin (“ATB”).

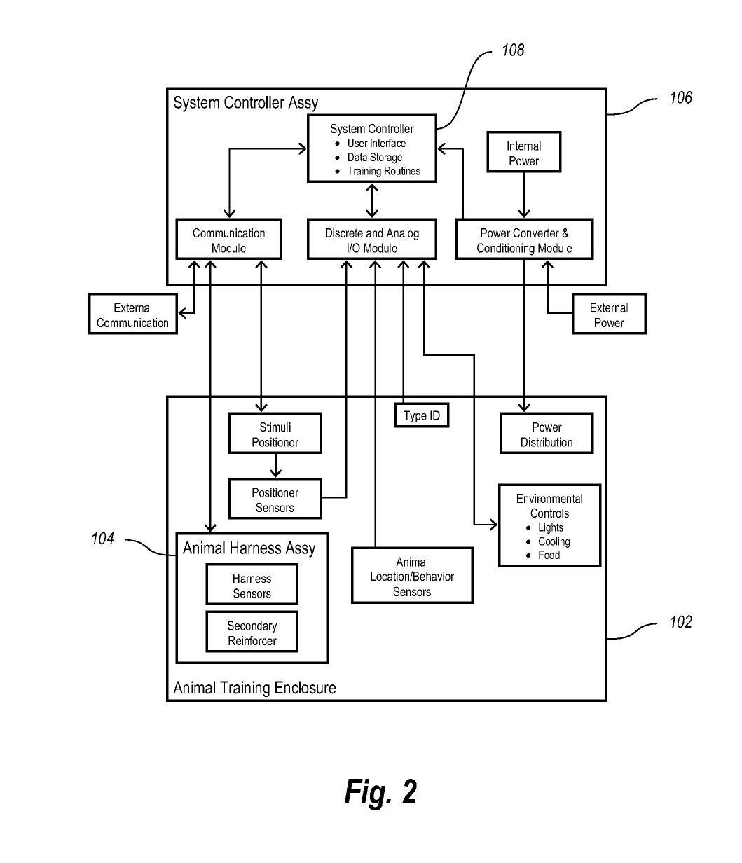

A more detailed RAT System architecture is depicted in FIG. 2. The system architecture shows some of the communication, signal, and power pathways between various components of the system.

The system controller assembly 106 can include a system controller 108, such as a laptop computer or other type of computing device, which is connected to modules internal to a chassis that provide I/O functionality. Training data can be stored and maintained in the system controller and be easily exported via a data interface panel that can have common connections such as USB and/or Ethernet. A graphical user interface, such as a touch screen or monitor, can be used to display system and testing information and guide the user through the animal testing phases.

The animal training enclosure 102 can provide a chamber in which animals can be trained and can include multiple positions for stimuli to be placed along with stimuli control interfaces. The animal can complete all of the levels of training within the animal training enclosure until ready for field testing. Sensors can keep track of stimuli positions and animal nose pokes related thereto so that the target stimulus can be randomly moved and the animal evaluated. In addition, the animal training enclosure 102 can provide environmental regulation and appropriate lighting conditions.

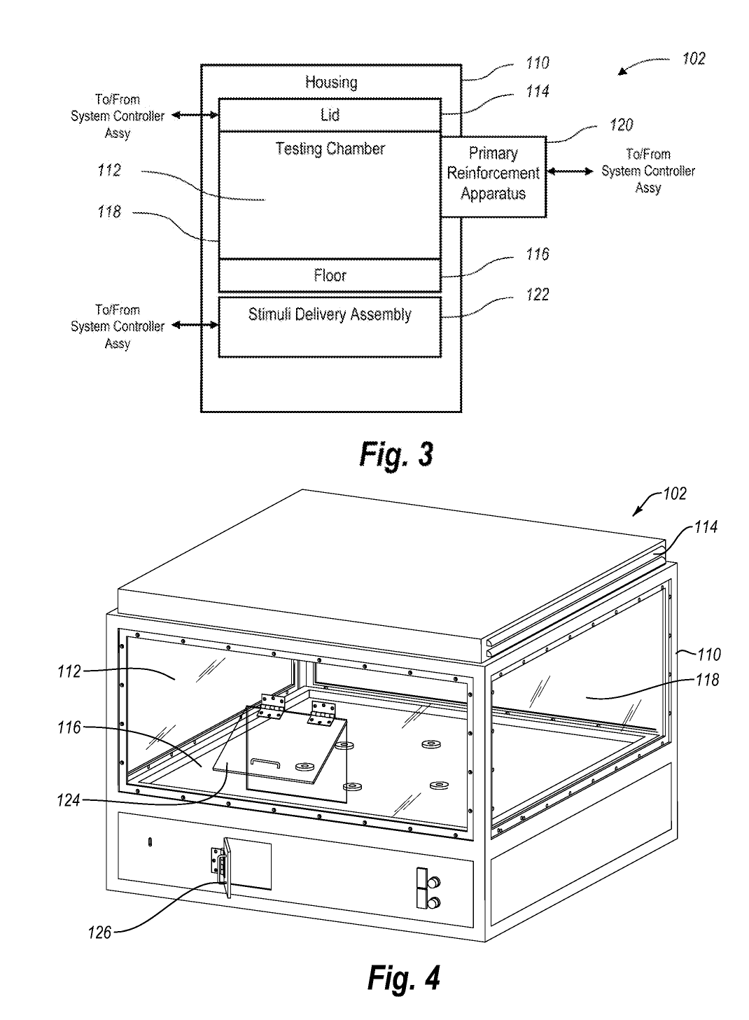

One embodiment of an animal training enclosure 102 is depicted in FIGS. 3-5. The animal training enclosure 102 can include a housing 110 that bounds a testing chamber 112 in which the animal is positioned during testing. The housing can have a lid 114 and floor 116 and multiple sidewalls 118. A primary reinforcement apparatus 120, such as a food dispenser, can be included that communicates with the testing chamber and provides a reinforcer, such as food, to the animal when the animal has accomplished a task. The animal training enclosure 102 can also include a stimuli delivery assembly 122 that positions target and distracter stimuli used during training of the animals.

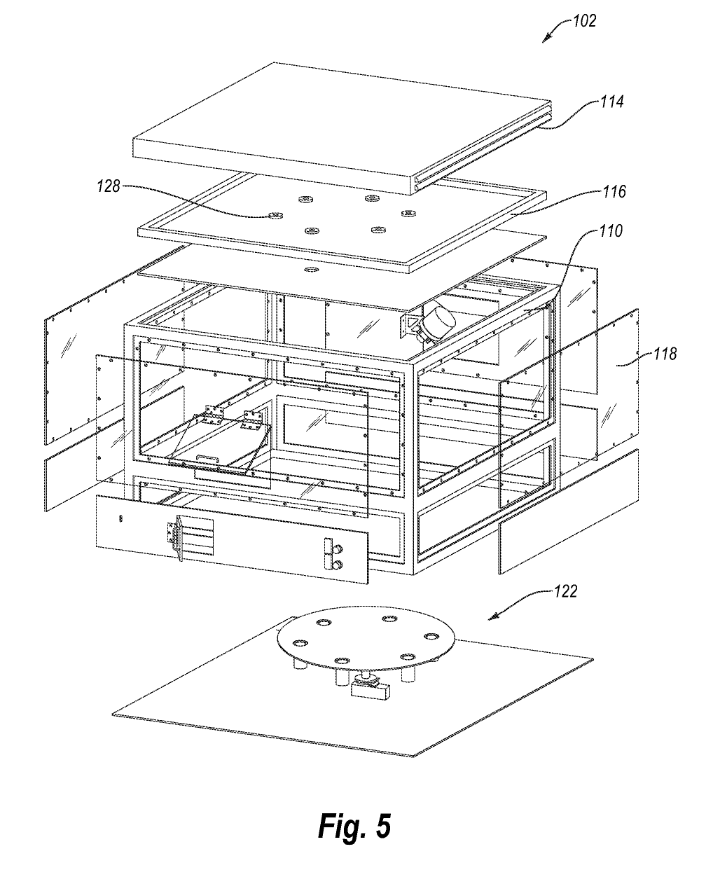

As illustrated in FIGS. 4 and 5, the housing 110 comprises a lid 114, four sidewalls 118, and a floor 116 that bounds the testing chamber 112. The testing chamber 112 is where the animal works when executing a training session. A testing chamber access door 124 can be positioned on one of the sidewalls to allow the user to place the animal into the testing chamber and remove the animal therefrom. The housing 110 can also include a subfloor and corresponding sidewalls to house the stimuli delivery assembly with a stimuli delivery assembly access door 126 positioned on one of the sidewalls to allow the user to access the stimuli delivery assembly.

The lid 114 is used to contain the animal within the testing chamber 112 during training and can also be used to provide lighting, ventilation, and other environmental controls. For example, in the depicted embodiment, ventilation louvers are included on either side of the lid for ventilation purposes. Screens can be mounted internally to keep insects from entering into the testing chamber. Air can be pulled up through perforations in the side panels and expelled out the lid louvers whenever the training chamber exceeds a predetermined maximum threshold temperature. The maximum threshold temperature can be easily adjusted to accommodate the different maximum working temperatures of different species. This information can also be sent to the system controller so that the trainer can be notified that training may need to be terminated when the temperature in the animal training enclosure exceeds the working maximum. LED lighting strips can also be included in the lid to signal that a training session is in progress by automatically illuminating during a training session, and turned off when the session is completed.

The floor 116 provides a surface that the animal can easily navigate during training sessions. The floor can include odor portals 128 through which the animal can be exposed to odor stimuli positioned under the floor. Each portal 128 can be equipped with a nose poke detection sensor to detect nose poke intrusions into that portal by the animal. The sensors can be used in conjunction with behavior sensors on the animal harness assembly to determine when an animal has performed correctly or incorrectly based on the portal into which the animal poked its nose, as discussed in detail below. The odor portals 128 may also be referred to as sniffing portals herein.

The housing 110 can be ruggedized and can be designed to be easy to set up and take apart. In the embodiment shown in FIGS. 4 and 5, the housing 110 is 40 inches (101.6 cm) long by 36 inches (91.44 cm) wide and weighs approximately 40 lbs (18.1 kg) and is constructed of 1.5 by 1.5 inch (3.81 by 3.81 cm) aluminum extrusion tubing. The sidewall panels 118 consist of acrylic and the lid 114 is comprised of aluminum. The sides and bottom of the subfloor portion are aluminum. Of course, other sizes and weights can also be obtained using the same or different materials.

The housing 110 can be constructed to withstand rough handling and can have an easy snap together design, for example, by using aluminum castings for joints. By doing so, acrylic panels can be field replaceable without tools, when replacement is needed. The removable acrylic side panels can also allow the trainer to easily clean out the training chamber during regular maintenance.

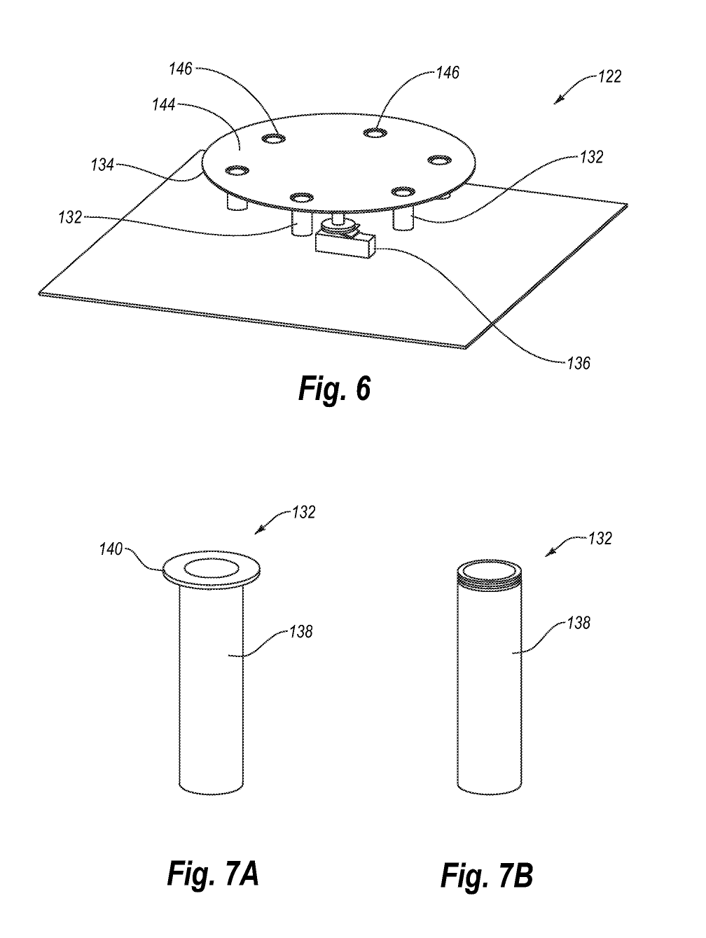

As noted above, the stimuli delivery assembly is used to position target and distracter stimuli used during training of the animals. FIG. 6 shows one embodiment of a stimuli delivery assembly 122 using a Carousel Canister System (CCS) positioned underneath the floor (see FIG. 5). As shown in FIG. 6, the stimuli delivery assembly 122 can include a plurality of containers 132 to hold target and distracter stimuli, a positioner 134 to hold the containers 132, and an actuator 136 to move the positioner and containers positioned thereon.

The containers 132 can be used to hold the target and distracter stimuli, which are presented to the animal through the odor portals 128 on the floor of the training chamber. In the embodiment shown in FIG. 7A, the container 132 comprises a canister 138 having a tubular main body that is open on one end. An annular flange 140 radially extends outward from the main body at the open end thereof so as to encircle the mouth of the opening. The flange 140 can be used to secure the canister 138 to the positioner 134. Alternatively, the flange 140 can be omitted and the open end can be threaded, as shown in FIG. 7B, to be used to threadedly secure the canister 138 to the positioner 134. Other means for attaching the canister 138 to the positioner 134 can also be used.

In one embodiment, the canister is designed to hold about six ounces (170 g) of material. Of course other sizes and types of containers can be used to hold different amounts of material. To perform animal testing, each canister 132 is filled with a sample comprising one or more targets (i.e., a substance that emits a target odor), one or more distracters (i.e., a substance that emits a distracter odor), or a combination of both.

The samples can be made of a standardized media to which known amounts of target odor chemicals are added, or can be local soil. An advantage of using local soil as a distracter is that there is no need to artificially mimic complex properties of the background distracter odor mixture to which the animals will later be exposed in field operations. To guard against using old or expired targets and distracters, unique identifiers, such as bar codes, can be placed on each canister 132 and critical data such as the type of odorant contained inside and the expiration date can be stored on the RAT System 100. The user can then be notified when an expired or incorrect canister 132 is positioned in the carousel system 122 for a training session. In one embodiment, testing will not be allowed to proceed until the situation is remedied.

The targets can be controlled to ensure quality training using records to document how the animal was trained to achieve animal certification as needed. For example, after filling one or more canisters 132 with precisely measured amounts of a target, bar codes can be placed on the canisters 132 and the canister information can be stored in a data repository, such as a U.S. Army or controlling agent data base. Important information such as chemical composition, restrictions, handling procedures, and expiration data can be tied to the particular canister 132 by virtue of the associated bar code. When the canisters are delivered to the local user, a CD or other type of data storage device can be provided to load the bar code numbers and associated information onto the local RAT System 100. If desired, samples for training target canisters 132 can be generated by a government or a government representative so that controlled substance targets are properly handled and to maintain training accuracy and repeatability.

If desired, a distracter can be created in the field and can be made to include odors that the trained animals typically encounter in the local flora and fauna of the area to be demined. The distracter can simply comprise local soil, or can include other materials, depending on the area to be demined. The RAT System 100 can provide suggested distracters, based on suggestions included with the data storage device supplied with the RAT System. Once the distracter canisters 132 are created, then these too can be barcoded and entered into the system.

In one embodiment, the end user receives a box of canisters 132, some filled and some empty. The filled canisters 132 can comprise target canisters that may be registered and controlled. The user may not have to do nothing with these canisters except load them into the carousel 134 when directed by the system controller 108. The filled canisters can be color coded, if desired, to differentiate them from other canisters. For example, the filled canisters can be red with a black stripe. In one embodiment, the end user does not modify or open these filled canisters.

The empty canisters 132 can be filled locally with distracters to become distracter canisters. As with the filled canisters, the empty canisters can also be color coded, if desired. For example, the empty canister can be green with no stripe. In one embodiment, the empty canisters can be filled with local dirt and then be ready for training use. As discussed above, one or more of the canisters can have identifiers, such as barcodes, attached thereto.

In some embodiments, one or more of the canisters 132 can contain a target to which a distracter, such as local soil, can be added to produce a mixed target/distracter canister 132. To ensure that the quantity of the target does not get changed when adding the distracter, the controlled target can be sealed in a permeable packet that is attached to the inside of the canister. The canister 132 can then be opened and the distracter added to the canister without the controlled target being disrupted. This can allow both target and distracter in the same canister while maintaining target quantity control.

One benefit to using the above approach for the canisters 132 is that calibration may not be required in the field. The controlled target samples can be generated at a controlled facility that can verify that the precisely measured amounts of targets are used.

Returning to FIG. 6, the positioner 134 is used to hold the containers 132 below the floor 116 of the training chamber 112 so that the containers can be aligned with the odor portals 128. In the depicted embodiment, the positioner 134 comprises a carousel interface plate 144 having a plurality of container or canister ports 146 positioned thereon. The canister ports 146 are designed to align with the odor portals 128 of the floor 116. Each canister port 146 is sized and shaped to receive and removably secure one of the canisters 132 therein.

For example, each canister port 146 can be countersunk or have an annular flange extending into the canister port, if desired, to catch on the flange of the canister 132 shown in FIG. 7A. If a threaded canister 132 is used, such as the canister shown in FIG. 7B, each canister port 146 can have threads that mate with the canister threads so that the canister can be secured in the port by threaded connection. As noted above, other means for attaching the canister 132 to the positioner 134 can also be used. As shown in FIG. 6, the canisters 132 can hang from the bottom side of the carousel interface plate 144.

The canister ports 146 are positioned circumferentially around the outer edge of the carousel interface plate 144 so that as the plate 144 is rotated about its center, each canister port 146 can become aligned with a different odor portal 128. The depicted carousel interface plate 144 contains six canister ports 146, although fewer or more canister ports 146 can alternatively be used.

The actuator 136 is used to move the positioner 134 to align the containers 132 within the canister ports 146 with the odor portals 128 in the floor 116 of the training chamber 112. In the depicted embodiment, the actuator 136 comprises a rotary positioner, such as, e.g., a stepper motor having a shaft extending therefrom. The distal end of the shaft is securely coupled with the carousel interface plate 144 so that the carousel interface plate rotates as the shaft rotates. The actuator 136 can be electronically coupled with the system controller 108 via wired or wireless connection so that the system controller can command the carousel interface plate to rotate to desired angular positions, thereby causing particular canisters 132 to be aligned with particular portals 128.

Various sensors can also be included with the stimuli delivery assembly 122 to keep track of canister positions so that the target odor can be randomly moved and the animal evaluated. For example, an odor stimuli interface can consist of canister position sensors and canister type sensors.

It is appreciated that the CCS approach discussed above is but one approach that can be used to provide target and distracter odors to the animals being tested. Other approaches are also possible. For example, a Controlled Air Delivery (CAD) system can alternatively be used, if desired.

The CAD approach involves accurately supplying target stimuli air into the training chamber 112. Under the CAD approach, a solenoid array can be used to control the flow of several air supplies to mix precise amounts of filtered air with odor-saturated air and deliver the mixed air to an odor port in the test chamber 112. Although such an approach may be well suited for use with single odorants or simple odor mixtures in a controlled laboratory environment, it may not be ideal for use with embodiments of the present application. First, the CAD approach is generally limited in its ability to reproduce complex organic odor mixtures, like that of soil. Second, the CAD approach is more complex and more difficult to use by an untrained user. Third, the CAD approach generally requires more periodic maintenance and calibration than the CCS approach. Fourth, the CAD approach has higher material costs than the CCS approach.

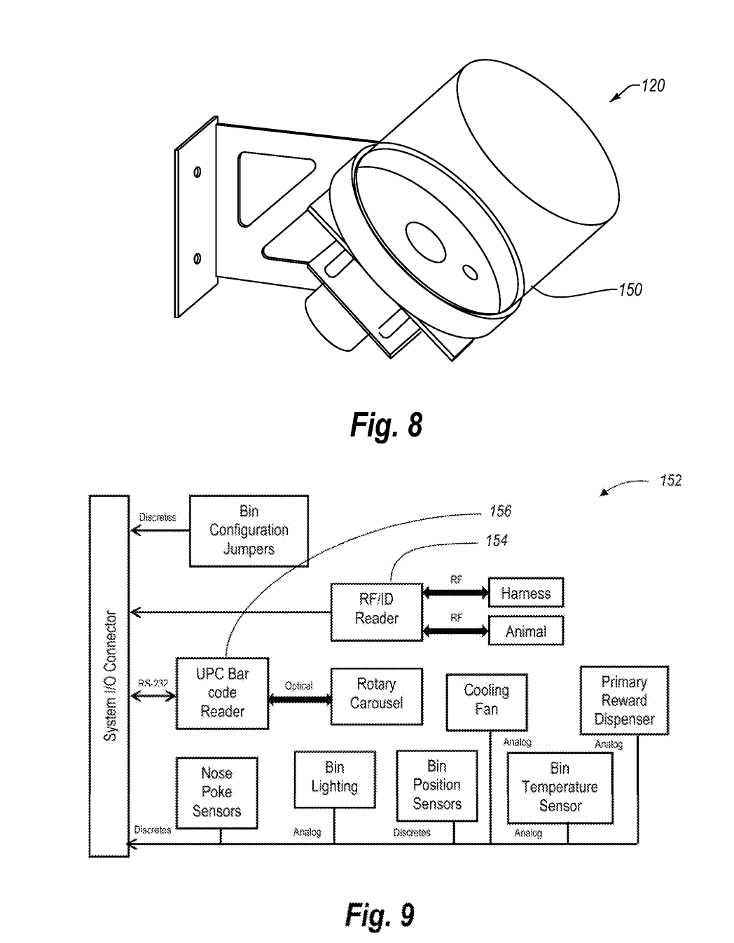

The primary reinforcement apparatus 120 is used to reinforce desired actions performed by the animal. In one embodiment, shown in FIG. 8, a food dispenser assembly 150 provides the primary behavior reward reinforcement to the animal during training. In this embodiment, solid food is used as the behavior reward and is dispensed for the animal when the animal completes a training task correctly. This assembly 150 can be equipped to dispense a liquid feeding reinforcement, if desired, for training different species. The feeder can be equipped with a sensor that verifies that food has been dispensed when commanded from the system controller 108.

FIG. 9 depicts an I/O functional design 152 that can be used with the animal training enclosure according to one embodiment. Highlights of the design include the RF/ID reader 154, which can be used to identify and track items positioned within the animal training enclosure, and the UPC bar code reader 156, which can be used to identify and track target and distracter canisters. The RF/ID can be used for animal and harness identification inside the animal training enclosure during a training session, and the UPC bar code reader 156 can ensure that the correct canisters are placed into the animal training enclosure during a training session.

For some locations it may be beneficial to have animal training enclosures of differing sizes for different types of animals. In other locations it may be beneficial to use a single size of training enclosure that can be adapted for use with different sized animals. In coming up with the size(s) and type(s) of animal training enclosures, various design factors can be taken into account, such as the size of the animals to be trained, environmental factors, the type of reward stimuli to be used, and the overall system and training complexity.

Animal size—This may be the most obvious manner in which the animal training enclosure can adapt to the species. For species like the Norway rat ranging from the 0.3 kg to an animal up to 7 kg differ in body size by a factor of 23. To accommodate the size differences, removable bin dividers can be used that are adjustable for species size. However, this places more burden on the user (assumes users range from uneducated to high school graduate), which then can increase the chances of errors in training, which can lead to less reliable results.

Environmental Factors such as lighting and temperature—most candidate species prefer and work better in dim light than in bright light, but species vary in their sensitivity to ambient light. Also, some species tolerate a wide range of ambient temperatures while others require stricter temperature control. Some species can be inhibited by ambient noise, while others are not. Thus ambient lighting/shading, ventilation, and insulation should be considered when building and using the animal training enclosure.

Type of reward stimuli—As discussed in more detail below, various phases of training involve delivering rewards (primary′ reinforcers that animals are instinctively motivated to obtain, usually food). But the type and size of the rewards can vary between different species.

Overall System and training complexity—Complexity of the user setup, designs of the animal location sensor and stimuli positioner, cost, integration of the animal harness assembly with its sensors, space requirements of the training facility, and control/consistency of training are all factors that can be considered regarding the design question between multiple sizes versus one universal size. Easy operator use is a priority requirement in some embodiments since those units may be fielded in locations, such as less developed countries, where educated people may be scarce. Limiting how much tasking the RAT System operator has to perform, may increase successful training sessions. A universal animal training enclosure to accommodate any species requires more hardware and software resources which drives system final cost upward.

The animal harness assembly 104 is used to provide information about the animal being trained and to provide a secondary reinforcement to the animal when appropriate. The animal harness assembly 104 may also include a marker delivery apparatus to place a marker at the site of a mine when one is detected during demining operations.

Two design approaches were considered for the animal harness assembly. The first approach was to use a wired tether system and the second approach is to use a wireless harness. The wired tether approach has the advantages of being lighter, not needing a battery, and using less expensive electronics. The wireless approach has the advantages of allowing the animal more freedom of movement and autonomy, eliminating any chance of entanglement of the animal in wires, and reducing wiring complexity. Although both approaches can be used, the wireless approach was considered superior and will be discussed herein

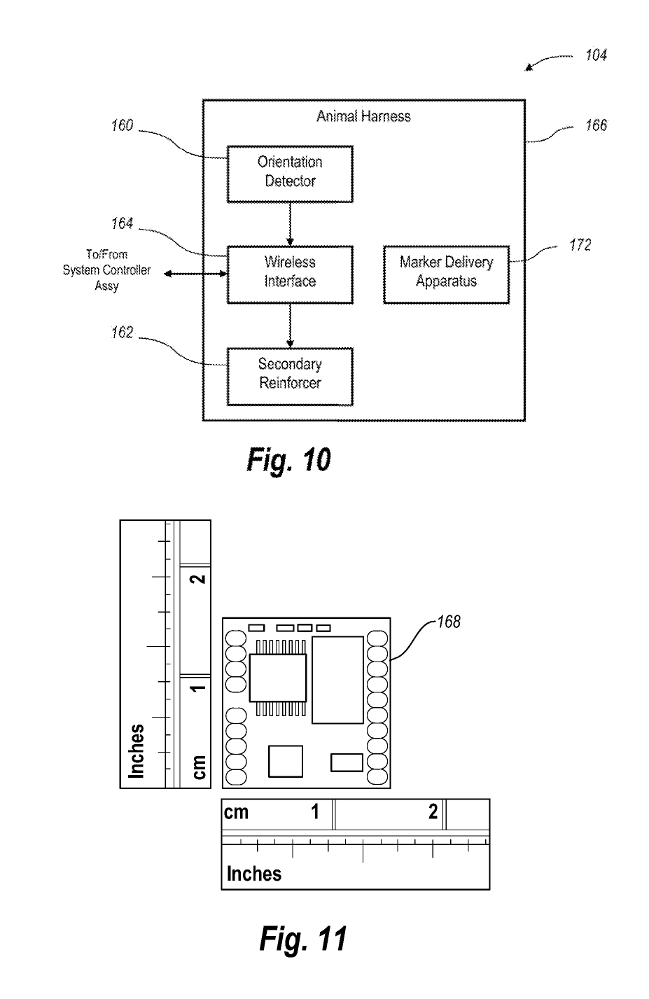

One embodiment of an animal harness assembly 104 is depicted in FIG. 10. As shown, the animal harness assembly 104 can comprise an orientation detector 160, a secondary reinforcer 162 and a wireless interface 164, all housed within an animal harness 166.

The orientation detector 160 is used to determine the orientation of the animal during training With it, circular motion in the horizontal plane can be detected. By monitoring the change in orientation during a training session, the system can determine if a particular change in orientation, such as, e.g., rotation of the animal, has occurred. As such, the animal can be trained to perform the change in orientation and then monitored to determine when that motion has occurred. The trained behavior can be performed by the animal when the animal has detected a target stimulus odor. This can be done by measuring rotation of the animal with the electronic compass.

In one embodiment, an electronic compass 168 can be used as the orientation detector 160. For example, a commercially available electronic compass, such as the OS4000-T manufactured by OceanServer shown in FIG. 11 can be used. Of course, other electronic compasses are also possible.

The electronic compass 168 is a 3-axis heading and attitude sensor. The electronic compass can provide the system controller with the data necessary to calculate if the animal is performing a target odor identification circling behavior. Measurements from the electronic compass 168 can be sent to the wireless transceiver card assembly 164 for broadcast to the system controller 108. If desired, for more accurate measurements, the electronic compass 168 can have built-in tilt correction so that when the harness 166 is not completely parallel to the earth's surface, corrections can be applied to the heading output of the device.

The secondary reinforcer 162 is used to provide a second reinforcement to the animal when the animal has performed a trained action at the appropriate time. As such, the secondary reinforcer 162 is used in conjunction with the primary reinforcer so that during training, the animal comes to associate the secondary reinforcer 162 with the primary reinforcer. Then, when the animal is used in a location where the primary reinforcer cannot be used, the animal will still respond to the secondary reinforcer. For example, because rats are motivated to obtain food, food is often used as the primary reinforcer. That is, when the animal performs in an appropriate manner during training, the animal is awarded with the primary reinforcer, food. In this manner, the animal “learns” appropriate behavior by determining which behaviors get rewarded with the food.

If a secondary reinforcer is always provided with the primary reinforcer, the secondary reinforcer can serve as a Pavlovian-type conditional stimulus, signaling the primary reinforcers availability to the animal. That is, if the secondary reinforcer is provided slightly before the primary reinforcer, the animal comes to “learn” that the secondary reinforcer leads to the primary reinforcer. For example, in conventional systems, a clicking sound is often used as the secondary reinforcer. By providing the clicking sound to the animal before the food, the animal learns this association and thus responds to the clicking sound with conditioned food-anticipatory behavior. Then, when the animal is used outside of the training enclosure, the animal will perform the learned behavior even if only the clicking is used without the food.

Although the traditional clicking sound can be used as a secondary reinforcer in the RAT System 100, one of the novel design features of one embodiment of the RAT System 100 is the development and use of a vibrotactile stimulator as the secondary reinforcer. Although not used before to provide secondary reinforcement to animals, the thought of using a vibrotactile stimulator in the RAT System came up in trying to determine how multiple animals could be trained simultaneously. Whereas all animals within a location may hear the clicking sound, only the animal wearing the vibrotactile stimulator will feel the vibration. Thus, to train multiple animals simultaneously using the clicking sound as the secondary reinforcer, each animal would need to be separated enough to not be able to hear the clicking sounds provided to the other animals, or sound proof barriers would need to be used. However, with the vibrotactile stimulator, all of the animals can be located close together and each animal will only feel the vibrations associated with its own stimulator.

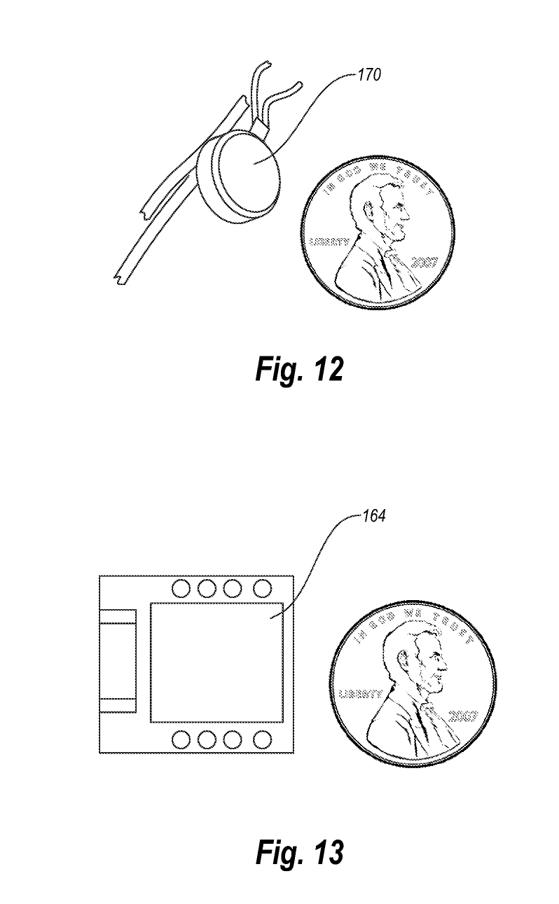

FIG. 12 shows one embodiment of a vibration motor 170 that can be used as the vibrotactile stimulator secondary reinforcer 162. The depicted vibration motor 170 is 10 mm in diameter, 3 mm thick and weighs 1 g, although other sizes and weights are also possible. Various off-the-shelf vibration motors can be used, such as, for example, models 312-101, 310-103, 310-105, and 310-113 manufactured by Precision Micro Drives. These vibration motors use an Eccentric Rotating Mass motor, which allow for a small physical packaging. These devices have an amplitude range of 0.9 to 1.7 G and a frequency range of 80 to 270 Hz. The frequency and amplitude can vary with the voltage applied to the device, meaning that a lower frequency and amplitude can be produced with a lower power input voltage. This variation in input power vs. operating characteristics may impact how often batteries contained within the harness need to be changed. In addition, the mounting of the device can impact how much the animal can sense the vibration. The number of layers and thickness of those layers that separate the animal from the vibration motor are all considerations that can be taken into account in the choice of characteristics of the vibration motor.

Because vibrotactile stimulation had never been used before as a secondary reinforcer with small animals, testing was performed to verify the efficacy of such an approach.

A first test was performed to determine how the animals would react to vibrotactile stimulation. The first test consisted of placing a standard lab rat in an aquarium with food scattered about. The naïve rat was equipped with a harness containing a vibration motor. The vibration was occasionally applied to the rat for about one second, while the rat was eating. The rat responded by stopping its activity about 0.5 to 1.0 seconds after receiving a vibration. The rat remained distracted, holding still for about 0.5 seconds. The rat quickly resumed its activity presenting no fright or flight behavior. This test was repeated with 4 naïve rats, yielding similar result for each rat. These test results verified that under low stimulus intensity, the animals react to the vibration, but with no aversive or escape responses, making the vibrotactile stimulation potentially ideal as a secondary reinforcer.

A second test was performed to determine if the vibrotactile stimulation would be effective as a secondary reinforcer. In a series of training sessions, six rats were trained in an operant conditioning apparatus while wearing a harness with a vibrator embedded in a backpack on the harness. During the test sessions, brief activation (approximately 0.5 sec) of the vibrator was immediately followed by delivery of a 45 mg food pellet to the reward delivery area of the operant chamber.

A first training session was conducted consisting of 50 to 60 vibrator-food pairings, spaced at randomly determined intervals of 2-4 minutes apart. During the first training session, the rats showed a progressive decrease in latency to retrieve the food pellet when the vibrator was activated. Specifically, the average latency for all of the rats was 99.3 sec in the first six trials and 4.2 sec in the last 6 trials. This decrease in latency showed that the first training session was successful in conditioning the rats to respond to the vibrator as a food-delivery signal. A second training session was conducted the following day where it was determined that the conditioning was retained by the rats.

For comparison, four control rats were trained in sessions involving vibrator activation unpaired with food delivery. In the control training session, the two stimuli occurred throughout the session at random times relative to each other, so the vibrator did not signal food delivery. The control rats did not show the same progressive decrease in pellet retrieval latency, further validating the results of the testing. The control rats also did not show increased latency, indicating that there is not a general anxiogenic effect of the vibrator.

Returning to FIG. 10, the wireless interface 164 is used to communication with the system controller assembly 106. The wireless interface 164 is configured to transmit information obtained from the orientation detector 160 and to receive information for the secondary reinforcer 162. For example, the wireless interface 164 can periodically obtain data representing the orientation of the animal from the electronic compass 168 and transmit that data to the system controller assembly 106. Similarly, the wireless interface 164 can receive a command from the system controller assembly 106 to turn the vibration motor 170 on or off and the wireless interface 164 can forward that command to the vibration motor. The information can be data, commands, or other types of information. Other information can also be received and transmitted.

The wireless interface 164 can comprise any commercially available wireless transceiver. For example, transceivers using cellular, satellite, infrared, Bluetooth, or any other type of wireless communication protocol can be used. Factors that can be considered for selecting the wireless interface can include size, weight, type of communication interface and power consumption. One embodiment of a wireless interface 164 that can be used with the present invention is shown in FIG. 13. It is a commercial Bluetooth interface, model number OBS411, manufactured by ConnectBlue. Of course, other wireless interfaces can alternatively be used.

Returning to FIG. 10, a marker delivery apparatus 172 can be used to place a marker at the site of a mine when one is detected by the animal during demining operations. The marker delivery apparatus 172 can be configured to automatically deliver the marker when the animal performs the learned behavior that signifies detection of a mine. For example, in one embodiment, the marker delivery apparatus 172 can comprise a pocket filled with a marker substance, such as brightly colored ink, powder, or the like. The pocket can be designed so that the marker substance is automatically dropped onto the ground when the animal performs the learned behavior, e.g., by gravity or centripetal acceleration. Other types of markers and corresponding marker delivery apparatuses can alternatively be used.

One or more batteries can be used to power the electronics contained with the animal harness. Many factors such as size, weight, re-chargeable vs. disposal, amp-hour capacity, voltage level, voltage level vs. remaining capacity characteristics, capacity of converting the chemical energy from the battery, and logistics of battery changing/recharging can be considered when determining the batteries.

One design decision is the tradeoff between disposable and re-chargeable batteries. Disposable batteries appear easier to use by removing the re-charging step, but the logistics of obtaining batteries could pose obstacles. The user would need to acquire batteries of the required form factor that may be hard to find in less developed locations.

An advantage of re-chargeable batteries is to eliminate acquiring batteries by the end user. However, using a re-chargeable battery adds a step of re-charging the battery, and a power source and charger must be determined. This may be an issue, depending on where in the world the RAT System is going to be used. In one embodiment, the battery can be recharged using the USB or other port on the system controller computer. If desired, inductance wireless charging can be used. With inductance wireless charging, the animal harness can simply be placed on a pad at the end of the day that is attached to a power source, and the battery would charge overnight.

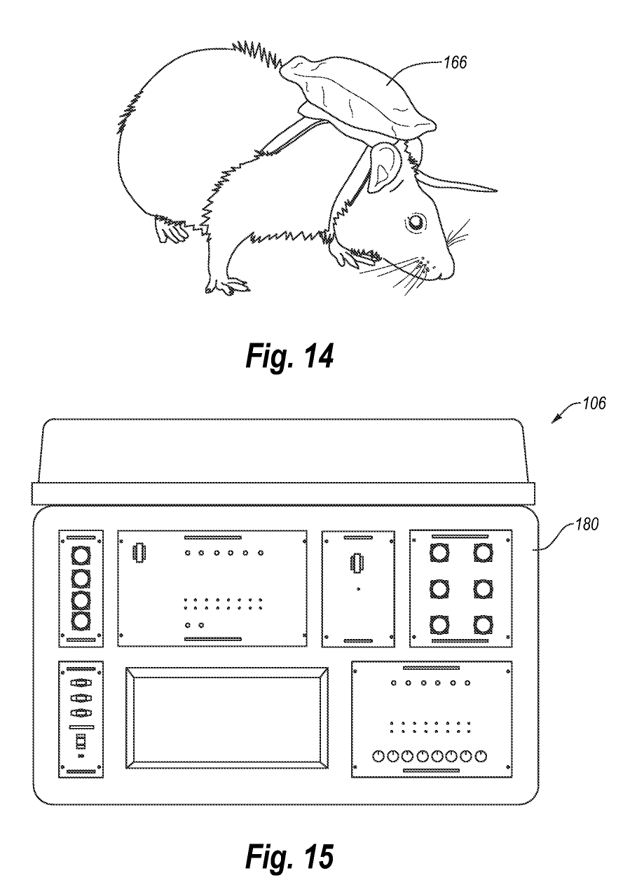

The animal harness 166 is worn by the animal and houses the orientation detector, the secondary reinforcer, and the wireless interface. FIG. 14 shows one embodiment of a backpack style harness 166 being worn by one of the subject animals. A closeable pocket can be included in the harness to house the electronics so that the electronics can be removed, when desired. In some embodiments, the backpack can be simple and, if desired, essentially disposable. In those embodiments, the harness can be easily replaced, repaired, or even custom made for local animals.

In some embodiments, the backpack consists of two or more detachable sections. In a first section that is strapped onto the animal, no electronics are contained. Instead, a second section that is detachable from the first section is used to house the electronics. The second section can be attachable to the first section using buttons, snaps, double-sided tape, a hook and loop connector (such as Velcro®), or any other type of connector. This can allow the electronics to be easily attached and removed. In these embodiments, a large number of harnesses 166 can be provided while a small number of the electronic packets (containing the orientation detector, the secondary reinforcer, the wireless interface, and a battery) can be used since the packets can be easily removed from one animal and attached to the next animal scheduled for training

In some embodiments, each animal harness 166 has an RFID tag that can be used by the system controller to keep track of the harness as well as the training time for each harness, and then notify the user to replace or re-charge the battery.

The system controller assembly 106 houses the system controller, the user interface assembly and other system components used to control the training of the animals. The system controller assembly 108 can provide the following: electronic control of the animal training session performed by the user; modules that provide communication, discrete, and analog interfaces; control and system checks of the animal training enclosure electronics; and control of the wireless network with the animal harness assembly 104.

FIG. 15 shows one embodiment of a system controller assembly 106. The system controller assembly 106 can include the electronic system controller 108, a user interface assembly, a wireless interface, and other electronics and cabling disposed within a system controller assembly housing 180.

The heart of the system controller assembly 106 is the system controller 108. The system controller 108 is an electronic computing device, such as a laptop or other type of computer, which is used to monitor and control the testing and training of the animals. The system controller can use data obtained from the animal training enclosure 102 and the animal harness assembly 104 to determine when reinforcers should be activated during training and can determine the level of training for each animal. The system controller 108 can also direct the uneducated trainer in the preparation of the animals, the reinforcers, and the stimuli for each training session, as well as direct the user through the testing phases. Training data can be stored and maintained in the system controller and externally exported, if desired.

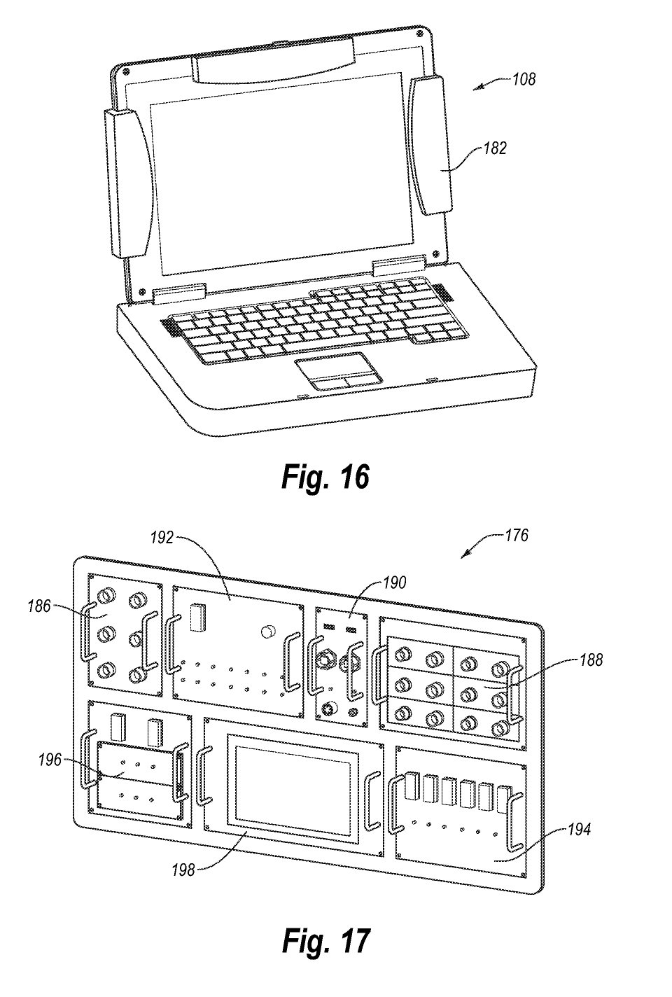

FIG. 16 shows one embodiment of a system controller 108 in the form of a laptop computer 182. The laptop computer 182 can be ruggedized, as in the depicted embodiment, but this is not required. For example, the laptop computer depicted in FIG. 16 is a commercially available laptop computer called the Toughbook and manufactured by Panasonic that can be used.

If desired, the laptop computer 182 can incorporate a touchscreen monitor 184. The touchscreen monitor 184 can lend itself to the concept of an easy to use operator interface, where user selections can consist of simply selecting various soft keys on the monitor. Of course, a traditional mouse or trackball can also be used. Environmentally, the laptop computer 182 can meet MIL-STD-810G, if desired, which covers shock, vibration, dust, moisture, and temperature operating range. The keyboard can be covered with a membrane to keep moisture out of the unit, and the monitor can be sunlight viewable with a screen cover to protect the monitor. The laptop computer 182 can contain internal memory for software program storage and execution and one or more removable memory devices, such as an SD drive, CD drive, and/or DVD drive, for storage and removal of training data when needed. The laptop computer can also incorporate a wireless interface, such as a Bluetooth interface, to allow wireless communication with the animal harness assembly 104.

The laptop computer 182 can include execution code that is stored in internal member. When executed, the execution code can cause the laptop computer to perform part or all of one or more of the methods discussed or envisioned herein. The execution code can include software that controls the stimuli in each test chamber and collects data on the responses of the animals.

The user interface assembly includes various panels, modules, and other devices that the user of the RAT System 100 may need to interface with. The user interface assembly can be designed to be easily accessible by the user and can be ruggedized and/or designed to protect the system controller assembly components from the external environment, such as from sand, dirt, water, insects, or the like. For example, while the panels can be made of any type of material, 6061-T6 aluminum alloy can be used for especially harsh environments, if desired. This aluminum allow is hardened and has good anti-oxidation properties. Furthermore, sub-panels can be equipped with gaskets so that water does not penetrate therethrough.

One embodiment of a user interface assembly 176 is shown in FIG. 17. The user interface assembly shown in FIG. 17 includes an external power interface panel 186, an animal training enclosure interface panel 188, a communications interface panel 190, a power conversion panel 192, a system I/O panel 194, a power or battery module 196, and a user display/input device 198.

As shown in the depicted embodiment, each panel or module can be equipped with handles and thumb fasteners for easy removal. If desired, easily removable electrical connectors can be attached to each panel or module so that the electrical connector can be easily removed by the end user to disconnect the panel or module from the chassis. The connectors can be keyed, if desired, so that the connector can only be attached to its corresponding mating connector when re-installing the panel or module or installing a new, replacement panel or module. To make it easier for the user, the panel and/or modules can be designed so that no tools are required to remove or install the panel or module. Gaskets or other type of seals can also be used to prevent external matter from entering into the system controller assembly housing.

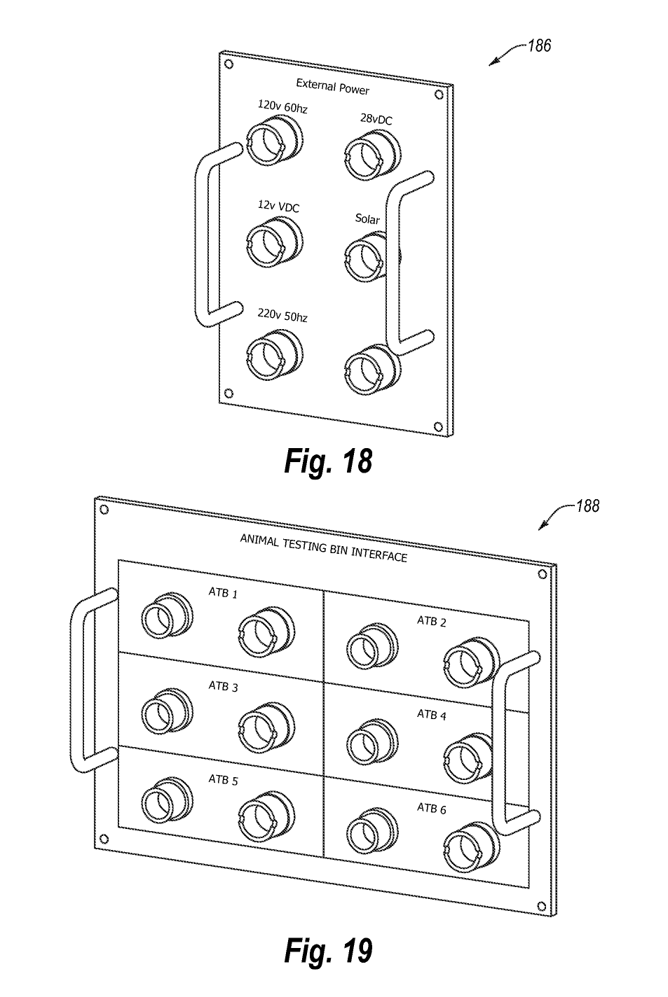

The external power interface panel 186, shown in FIG. 18, is used to attach the system controller assembly 106 to external power. The user can attach power cables to this panel when operating the RAT System with an external power source. In some embodiments, the RAT System controller assembly 106 can operate using internal regular or rechargeable batteries in place of or in conjunction with external power.

In one embodiment, the system controller assembly 106 can accommodate most types of external power sources, such as nearly any type of alternative current (AC) power available in the world, along with 9 to 36 volt direct current (DC) sources. If desired, the external power interface panel 186 can use military grade connectors for rugged and long lasting usage. Dust/water resistant covers can be provided for actual field operations to protect the connectors when not in use. Each connector can be provided with a unique mechanical keying so that cables can only be connected at the proper location. This can prevent the user from accidently attaching the wrong power type to the wrong location, preventing potential damage to the unit. Identifying nomenclature can be provided next to each connector to aid the user during cable installation.

The animal training enclosure power interface panel 188, shown in FIG. 19, is used to electronically couple the system controller assembly 106 to the animal training enclosure 102. The user can connect cables to this panel that run between the system controller assembly 106 and the animal training enclosure 102 to support operation of the animal training enclosure. For each animal training enclosure 102, up to two connectors can be connected at both the system controller assembly 106 and the animal training enclosure 102. One connection can supply power to the animal training enclosure 102 and the other connection can supply interface signals such as training chamber temperature, odor stimuli positioner command and position, lighting, cooling fan, bin type identifier, food dispenser, and animal position sensors. Other interface signals can also be incorporated.

Some examples of specific signals that provide the system controller 108 information about the animal training enclosure 102 include: if the cable is connected between the system controller assembly and animal training enclosure (Bin Connection ID), size of animal training enclosure (Bin Type ID), animal training enclosure address when using multiple animal training enclosures (Bin Address ID), training chamber temperature and ventilation (temperature +/− and fan +/−), and lighting control.

The system controller 108 can also retrieve training session information, monitor animal position, and control the placement of the targets and distracters using various interfaces. The system controller can receive identification of the target canisters(s) 132 within the animal training enclosure 102 which can be provided by the serial link between the UPC bar code reader 156 and the system controller 108. Also, the system controller 108 can determine when the animal is sniffing the portal 128 that contains the target stimuli via the nose poke sensors and the location of the animal as it moves about the bin via Aux position sensors. The system controller 108 can command the rotary carousel 144 to random positions during training sessions via a carousel command, and then monitor the position of the carousel 144 via a carousel position sensor. The primary reinforcer (Food Dispenser Command +/− and Food Dispenser Sensor +/−) can also be provided by the system controller 108.

In the depicted embodiment, six sets of connectors can be used so that the system controller assembly 106 can simultaneously operate with six separate animal training enclosures 102. In one embodiment, the RAT System 100 can be set up to sense if the interconnect cables have been installed prior to allowing a training session to start. The connectors can be supplied with dust/water resistant covers and be keyed to prevent the operator from connecting to the wrong locations. Identifying nomenclature can also be provided next to each connector for simple cable connections.

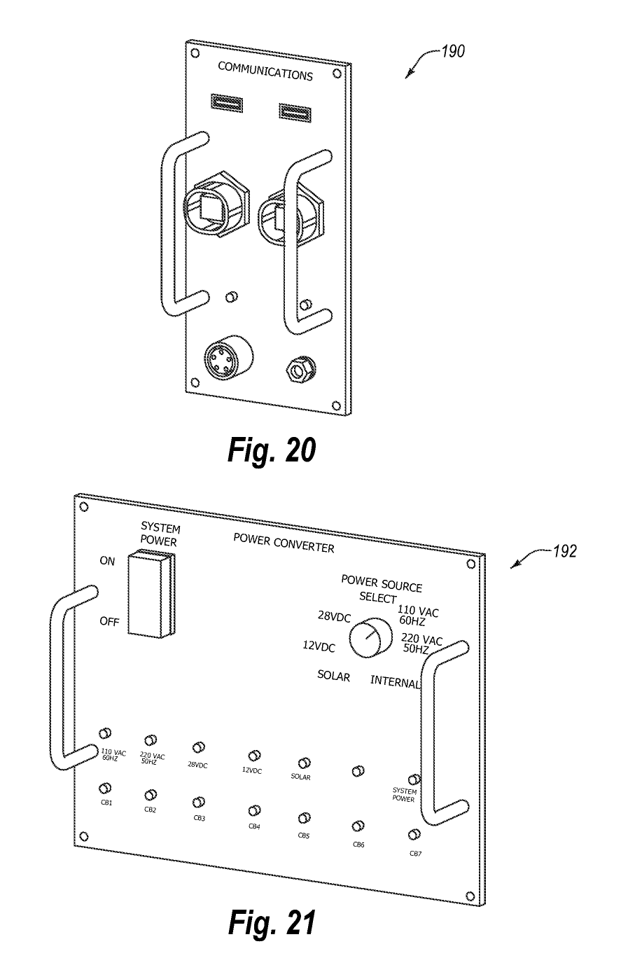

The communications interface panel 190, shown in FIG. 20, is used to provide access to common external interfaces, such as USB and Ethernet interfaces. The communications interface panel 190 allows external interfacing for data access as well as product development, future RAT System upgrades, and troubleshooting. In the depicted embodiment, two ports are supplied for each of the USB and Ethernet interfaces, although other numbers of ports can be supplied for each interface, if desired. Other types of external interfaces can also be used. The connectors can be supplied with dust/water resistant covers and be keyed to prevent the operator from connecting to the wrong locations. Identifying nomenclature can also be provided next to each connector for simple cable connections.

The power conversion panel 192, shown in FIG. 21, is used to control and monitor power within the RAT System. The power conversion module 192 can comprise switches, indicator lights, circuit breakers, and other power control and monitor devices. In the depicted embodiment, the switch on the upper left corner is the on/off power switch for the entire RAT System 100. The switch on the upper right corner is a rotary switch which allows the user to select the power source that is available to be used. In a horizontal row across the middle of the panel are indicator lights that when illuminated can alert the user that power associated with the lit light is available. At the bottom row of the panel are push-to-reset circuit breakers. These can protect the wiring and power supply modules from short circuit conditions.

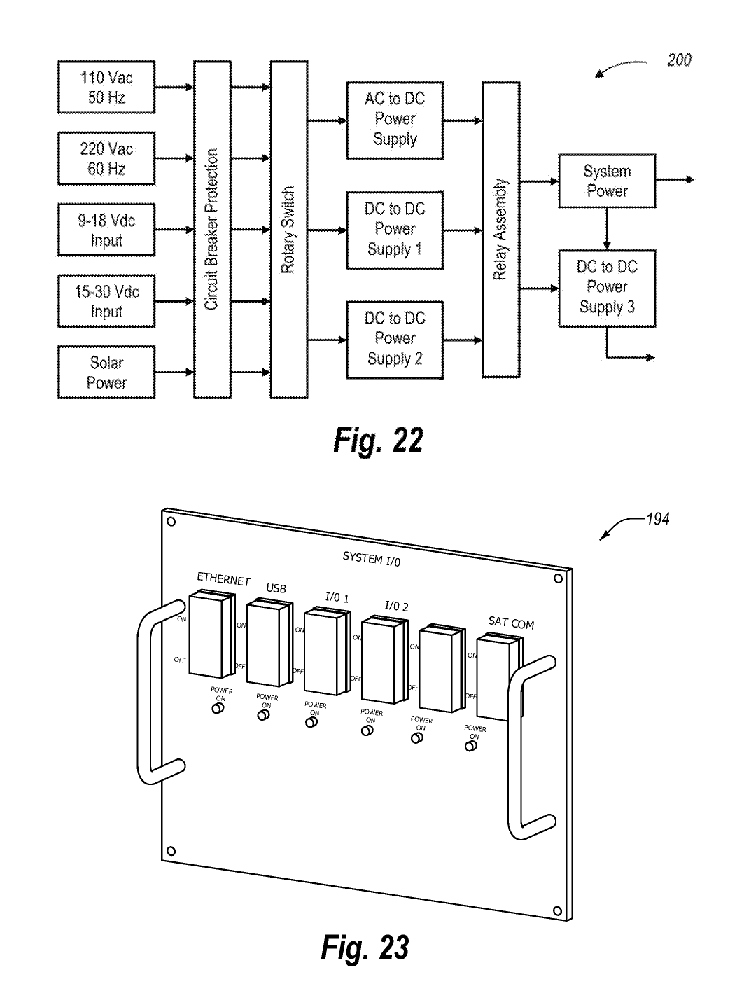

One embodiment of a system controller assembly functional power design 200 is shown in FIG. 22. The embodiment depicted includes a universal power supply that can accept both 50 and 60 Hz ac inputs, and two broad range input power DC to DC converters. DC power can be supplied to all the components within the system controller assembly 106 and animal training enclosure 102. A rotary switch can control power routing which is accessed via the power conversion panel 192. This switch can allow the user to select from multiple power inputs to be routed appropriately to the corresponding power supply or dc to dc converter.

The system I/O panel 194, shown in FIG. 23, allows the user to individually control power to system I/O modules and indicates when power is being applied to particular modules. The system I/O panel 194 can include on/off switches and indicator lights and the like. The switches can control the power to the system I/O modules and the corresponding indicator lights can illuminate when power is applied to any of the I/O modules. The system I/O panel 194 can also include, if desired: Ethernet switch, USB hub, USB to I/O interface, and Satcom radio, etc.

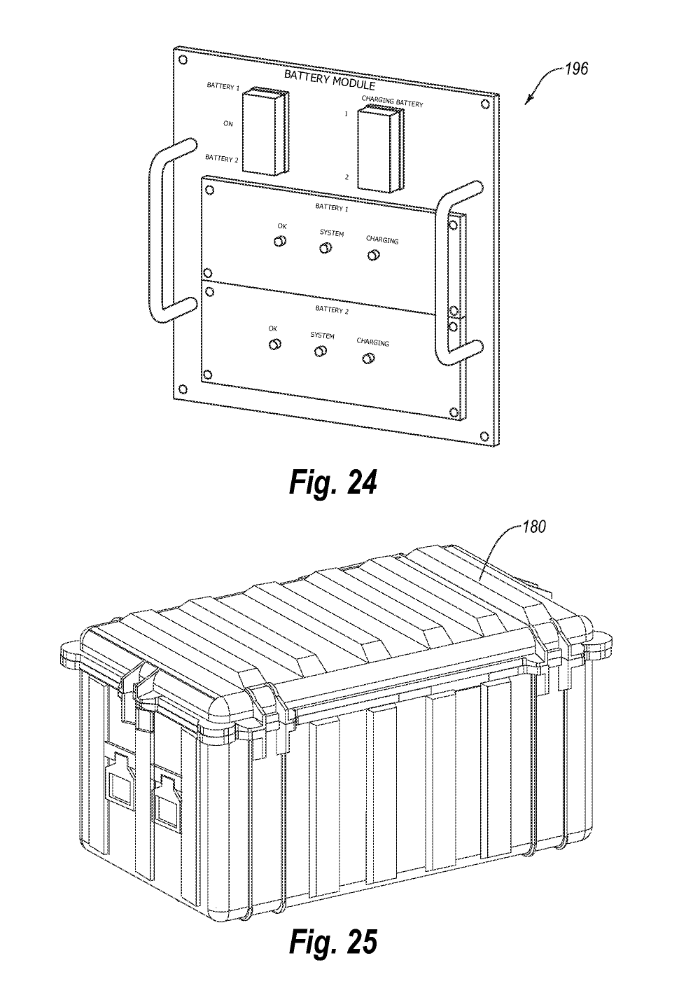

The battery module 196, shown in FIG. 24, can be used to house the batteries and allow the user to select the type of batteries to use as well as to determine the status of the batteries. The battery module can comprise a front user interface panel with control switches and indicators, battery housings, standard or re-chargeable batteries, such as re-chargeable lithium polymer batteries, and electronic control circuitry. The panel can also contain control switches and indicator lamps.

A first one of the control switches can allow the user to select which battery to use to operate the RAT System when external power is not available. A second control switch can determine which battery is being charged. The indicator lights can show the user when the battery contains enough charge for normal operation, when the battery needs to be recharged, and when a battery is being recharged.

In one embodiment, two re-chargeable Lithium-polymer batteries provide power to the RAT System. Each battery can operate the system for approximately four hours. In one embodiment, animal training sessions typically last 30 to 60 minutes, so one battery can perform between 4 to 8 training sessions on one charge in that embodiment. In one embodiment, the batteries can be charged within the system controller assembly when external power is applied or can be removed to be charged with an optional solar panel external charger. In one embodiment, the batteries can be easily removed without tools by using ergonomic fasteners. When external power is available the system controller 108 can prompt the user to charge the batteries when needed.

The user display/input device 198, shown in FIG. 17, is used to display output viewable by the user, as well as to receive input from the user related to the control and monitoring of the RAT System. The user display 198 can be a standard or ruggedized monitor that communicates with the system controller 108. Output displayed on the user display 198 can lead the trainer through the steps necessary to perform a training session. The user display 198 can double as the input device by including a touch screen to allow input from the user. Alternatively, a mouse, trackball or other inputting device can be used as the input device.

Using the user display 198, a plurality of graphical user interface (GUI) windows can be used. These GUI windows can initiate after the training application is launched from the system controller. The GUI windows can have options that the trainer selects by simply touching an appropriate location on the touch screen. Alternatively, a monitor coupled to the computer can be used as the user display, such as the built-in type of monitor that is integrated with a conventional or ruggedized laptop computer. Similarly, a mouse can be used instead of or in conjunction with the touch screen to select the appropriate locations.

The system controller assembly wireless interface 178 is used to communicate with the wireless interface 164 of the animal harness assembly 104. Thus, the system controller assembly wireless interface 178 is configured to receive information received from the animal harness assembly 104 related to the orientation detector 160 and to send information to the animal harness assembly 104 to control the secondary reinforcer 162. For example, the system controller assembly wireless interface 178 can receive the periodic data representing the orientation of the animal sent by the animal harness assembly wireless interface 164. Similarly, the system controller assembly wireless interface 178 can send a command to the animal harness assembly wireless interface 164 to turn the vibration motor 170 on or off. The information sent and received over the wireless link can be data, commands, or other types of information. Other information can also be received and transmitted.

Similar to the animal harness assembly wireless interface 164, the system controller assembly wireless interface 178 can comprise any commercially available wireless transceiver. For example, transceivers using cellular, satellite, infrared, Bluetooth, or any other type of wireless communication protocol can be used. However, the system controller assembly wireless interface 178 must be able to communicate with the animal harness assembly 104.

The system controller assembly housing 180 is designed to house and protect the various system controller assembly components. In some embodiments, the housing 180 can also be configured to make shipping of the RAT System relatively quick and easy. As such, in one embodiment, shown in FIG. 25, the housing 180 can comprise a standard shipping case having an internal compartment in which the components are housed. The shipping case 180 can have a lid that can close to seal the shipping case.

As noted above, the RAT System can be designed to be used in harsh conditions around the world. For example, various temperature extremes, such as, e.g., a range of −10 to 140 degrees F., humidity levels, dirtiness etc may be found in the areas where the RAT System is most needed. In addition, the RAT System may be needed in areas where there is minimal or no roofing or other protection from these elements. To allow for this, ruggedness features can be built into the housing to make it tough, durable, and able to operate in harsh conditions.

For example, a standard ruggedized container 180, such as is shown in the depicted embodiment, can be used as the housing. The ruggedized lid can cover and seal the container when the system is not in use. In addition, the user interface assembly (see FIG. 17) can be designed to be positioned at the top of the case (i.e., at the mouth of the internal compartment) so as to help prevent dust, water, etc, from entering into the internal compartment of the container, even when the lid of the container is open during use.

To help with this, each connector on the user interface assembly 176 can have its own attached captive dust cover, and contact plugs can be installed in unused contacts to keep water out of the internal compartment. Gaskets can also be used to seal the connectors, panels, modules, and assembly against penetration by water or other liquids. The switches and LED's can also be equipped to withstand water penetration. In addition, the system controller can comprise a ruggedized laptop computer certified according to industry and/or military ruggedization standards. For example, in one embodiment, the system controller 108 can comprise a ruggedized laptop computer certified to withstand: a six-foot drop, shock, vibration, rain, dust, sand, altitude, freeze/thaw, high/low temperature, temperature shock, humidity, and an explosive atmosphere according to MIL-STD-810G. The laptop computer can also be MIL-STD-461F certified, and IP65 certified sealed all-weather design.

As discussed above, for ease of shipping, a standard ruggedized case can be used as the housing. For example, in one embodiment, the system controller assembly 106 can be designed to fit within a standard ruggedized case having dimensions of 40×24×18 inches (101.6×61.0×45.7 cm) and weighing 50 lbs (22.7 kg). In one embodiment, cable assemblies can be stored in the lid section and the operator interface electronics can be located in the bottom portion. Of course, other types of housings can also be used.

As noted above, in some embodiments the animal harness 166 has a unique RFID tag. The system controller assembly 106 or the animal training enclosure 112 can correspondingly have an RFID tag reader that can be used to read the animal harness RFID each time the animal harness assembly 104 is used. Because the RFID tag is unique, the system controller 108 can use this information to keep track of the harness 166 as well as the training time for each harness, and can notify the user to replace or re-charge the battery in the animal harness assembly 104.

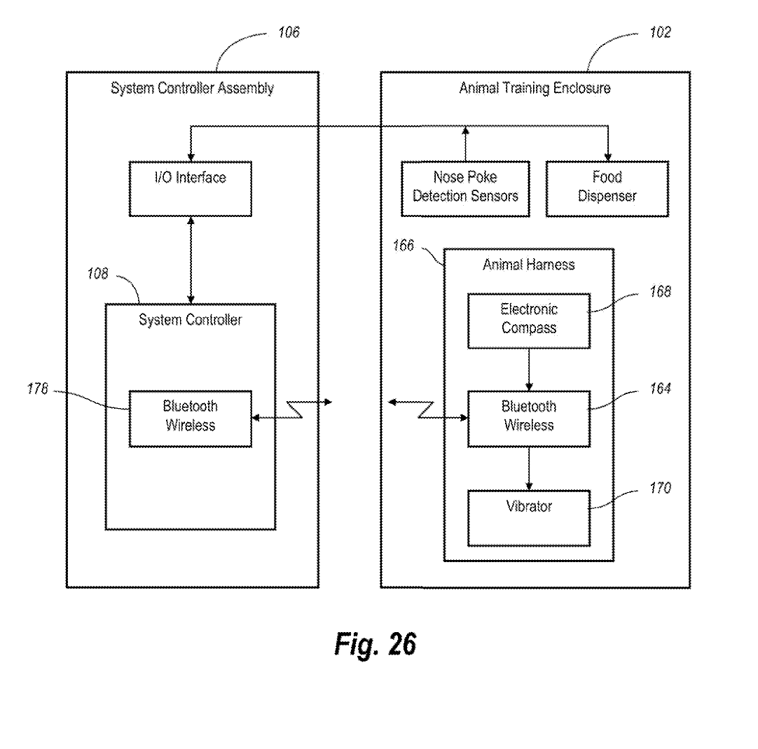

FIG. 26 is a functional block diagram showing how various components of the animal training enclosure 102, the animal harness 166, and the system controller assembly 106 discussed above can be used to test and train an animal according to one embodiment. The system controller 108 can receive data inputs relating to the positioning and behavior of the animal via the I/O interface and the Bluetooth wireless network. For example, as shown in the depicted embodiment, the inputs can include data from the nose poke detection sensors and electronic compass.

These data, among other data, can be used as inputs into an animal target odor Behavior Sensing Algorithm (BSA). The BSA can use the electronic compass data in conjunction with the nose poke sensor data and LED position grid information to determine when successful odor identification occurs. When it does, the system controller 108 can provide signals to actuate the primary and secondary reinforcers as an output of the BSA. In the depicted embodiment, the primary reinforcer is a food dispenser 150 that dispenses a food reward when the control signal is received from the system controller 108 through the I/O interface. In the depicted embodiment, the secondary reinforcer 162 is a vibrator 170 housed in the animal harness 166 that momentarily vibrates against the animal when the control signal is received from the system controller 108 through the Bluetooth wireless interface.

One of the benefits of using the RAT System is that multiple animals can be trained at the same time, if desired. That is, in some embodiments, more than one animal training enclosure 102 can be electronically coupled with the system control assembly 106 to allow a trainer to simultaneously train more than one animal, as shown by the dashed lines in FIG. 1.

To use more than one animal training enclosure, the individual animal training enclosures 102 can be linked in parallel to the system controller assembly 106. This can be done through the animal training enclosure interface panel, discussed above. For example, as shown in FIG. 19 and discussed above, the depicted animal training enclosure interface panel 188 has connections for six separate animal training enclosures 102.

To concurrently train multiple animals, the animal harness assemblies can also be linked in parallel to the system control assembly. For example, most wireless interfaces, such as Bluetooth, already allow concurrent connections, thereby allowing the system controller to wirelessly communicate with multiple animal harness assemblies at the same time.

Furthermore, by using the novel vibrotactile approach for the secondary reinforcer, the animal training enclosures can be kept close together without affecting the animal training that takes place concurrently. That is, the animals are not be affected by the traditional “clicking” secondary reinforcer that they would hear using that approach.

Being able to use multiple animal training enclosures provides many benefits. Of course, the biggest benefit is the ability to produce more trained animals in a shorter amount of time using only a single trainer. Other benefits include being able to use different sized animal training enclosures for different sized animals or different species of animals without having to change out the different enclosures, and being able to train the animals in a small space.

To help in using different-sized animal training enclosures, the RAT System can be designed to automatically recognize and configure itself to any size animal training enclosure, so that the user does not need to do anything other than attach an interface cable to the animal training enclosure.

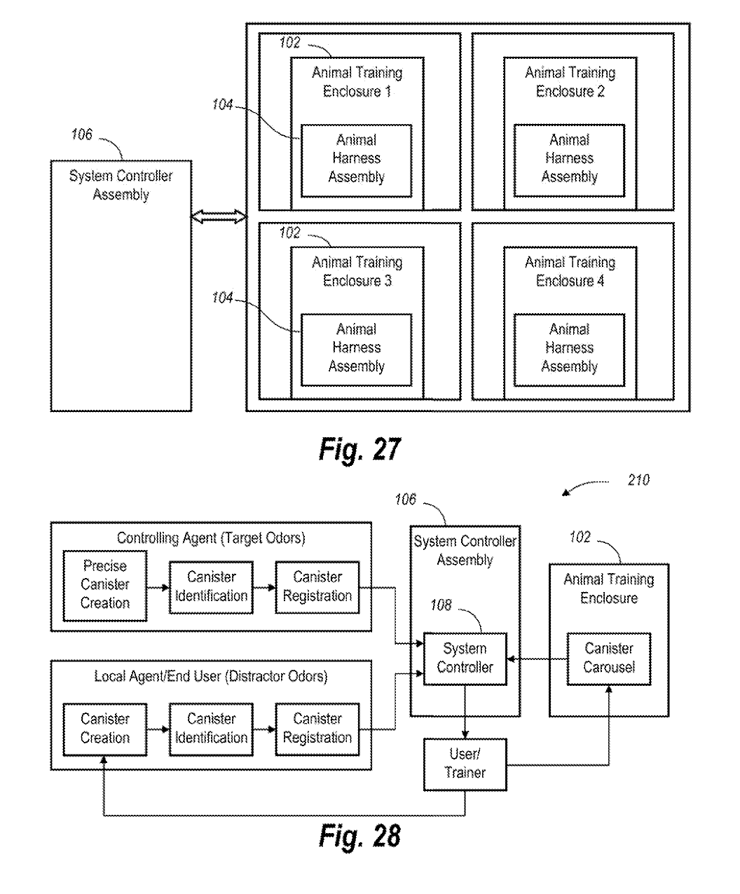

FIG. 27 shows an embodiment in which four cubicles are used to house four animal training enclosures 102 for concurrent use. As discussed above, each of the four animal training enclosures 102, along with the animal harness assemblies 104 that may be used therein, can be electronically coupled to the same system controller assembly 106 for concurrent testing. Of course, as discussed above, more or less than four animal training enclosures can be used concurrently.

In some embodiments, a camera can be positioned to view the training chamber. The video from the camera can be used for simultaneous video tracking during behavior tests and can be used to view training sessions live or recorded. If desired, the video can be used by the system controller to help in automatically detect training responses by the animals.

Various methods will now be discussed that can be used with the RAT System component embodiments discussed above.

Using the stimuli delivery assembly, several odor samples can be loaded and systematically introduced to the animal being trained. This method is simple to use for the operator and can allow for a simple operator interface.

In one embodiment, a dozen or more containers 132 can be filled with soil (including some targets and some distracters) and held on the carousel plate 144 underneath the training chamber 112, allowing for one to six stimuli odors or more to be sniffed via the ports 128 in the chamber floor 116, depending on the number of ports. From trial to trial, the system controller 108 can command the actuator 136 to rotate the carousel plate 144 to random positions so that a different subset of the samples becomes exposed through the ports 128. With the nose pokes and animal locations being monitored by sensors within the animal training enclosure 102, and the canister positions known, the correlation between animal response and system configuration can be determined.

FIG. 28 depicts a method for controlled delivery of target and distracter odors to the training chamber according to one embodiment. Each canister can be filled with either a known measured amount of a target or with a non-precise amount of a distracter, as discussed above. Also as discussed above, the pre-filled canisters can be bar coded or otherwise uniquely identified and the identifying information can be loaded into the system controller. In addition, the target canisters can be equipped with a tamper-proof device, such as a sticker, to ensure training quality.

When an animal is ready to be tested, the animal's RF ID tag can be automatically scanned and the corresponding unique identification entered into the system controller 108. The system controller 108 can check the system database and determine which pre-filled canisters should be loaded into the animal training enclosure carousel to meet that particular animal's evolving training needs at any given time in the animal's training process. The system controller 108 can inform the user/trainer which pre-filled target, target/distracter, and/or distracter canister(s) to load to perform the training session. Similarly, the system can inform the user/trainer if any canisters need to be filled to generate needed distracter and/or target/distracter canisters to use. After the user loads the canisters, the system controller can verify that the correct canisters have been loaded and training can then proceed.

As noted above, one benefit to using pre-filled canisters for the target odors, is that no calibration of these canisters is required in the field. The controlled target samples can be generated at a controlled facility that can verify that the precisely measured amounts of targets are used.

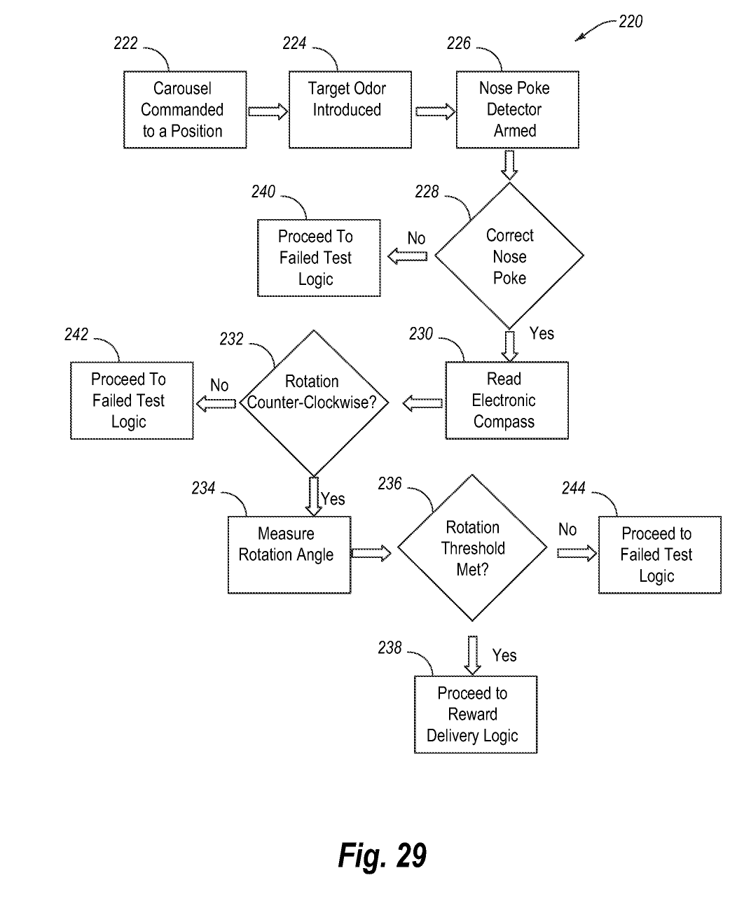

FIG. 29 shows one embodiment of a method 220 of training an animal to perform a trained behavior and to reward the animal accordingly that can be performed by the system controller after the canisters have been loaded onto the carousel. The method incorporates positioning a target odor, as discussed above, and using nose poke detection sensor and electronic compass data inputs, as also discussed above. It is appreciated that the depicted method is only one example of a method of training that can be used with embodiments of the present invention.

Step 222: The system controller first commands the carousel to move to a particular position that causes the target canister thereon to be aligned with a particular odor port in the floor of the animal training enclosure.

Step 224: Once the carousel has moved to the particular position, the target odor is introduced to the animal by opening the odor port that is aligned with the particular canister that is filled with the material from which the target odor emanates. Other odor ports may also be opened, depending on the stage of training being performed. The opening of the odor port(s) occur under the direction of the system controller.

Step 226: In conjunction with the opening of the odor port(s), the nose poke detector sensor corresponding to each of the opened odor ports becomes armed, if not already armed, either automatically or in response to separate command(s) from the system controller. The system controller then monitors for the nose poke sensors to be activated.

Steps 228 and 230: When one of the nose poke detector sensors have been activated by the animal, the system controller determines if the sensor corresponds to the target odor port. If the sensor corresponds to the target odor port, data from the electronic compass positioned on the animal harness is retrieved and interpreted by the system controller.

Steps 232-238: If the electronic compass data indicates that the animal has rotated in the appropriate direction, e.g., counter-clockwise, the rotation angle is determined by the system controller and measured against a predetermined rotation threshold, e.g., 720 degrees. If the determined rotation is greater than or equal to the predetermined rotation threshold, then the system controller signals the secondary reinforcer, e.g., the vibrotactile apparatus and/or the primary reinforcer, e.g., the food delivery apparatus, to deliver the corresponding reinforcement(s).

Steps 240-244: If the sensor does not correspond to the target odor port, or rotation in the appropriate direction is not indicated, or the rotation threshold is not met, the animal has failed the training session, the system controller proceeds to perform a failed-test routine, which records the particular failure against the animal, among other things.

The method incorporates positioning target and distracter odors, as discussed above, and using the nose poke sensor and electronic compass data inputs, as also discussed above

The method above can be adapted for more advanced training. For example to determine if the animal can distinguish between distracter odors and the target odor. For example, canisters containing distracter odors can also be loaded onto the carousel to determine if the animal can distinguish between distracter odors and the target odor. The distracter canisters can be positioned on the carousel so that the canisters become aligned with the other opened odor ports when the target odor is aligned with its corresponding odor port. Then, when the distracter and target odor ports are opened, the animal must distinguish between the odors.

The method can also monitor the animal to make sure that the trained behavior only occurs when the target odor is detected. For example, in some embodiments, instead of proceeding to a failed-test routine when an incorrect nose poke (i.e., a nose poke in a non-target odor port) is detected, the system controller can still retrieve data from the electronic compass and interpret it. This time, however, the system controller is looking to verify that the learned behavior, e.g. rotation, is not performed by the animal. If the learned behavior is detected, the animal has failed the training session and the system controller can act accordingly. Other modifications can also be made to the method.

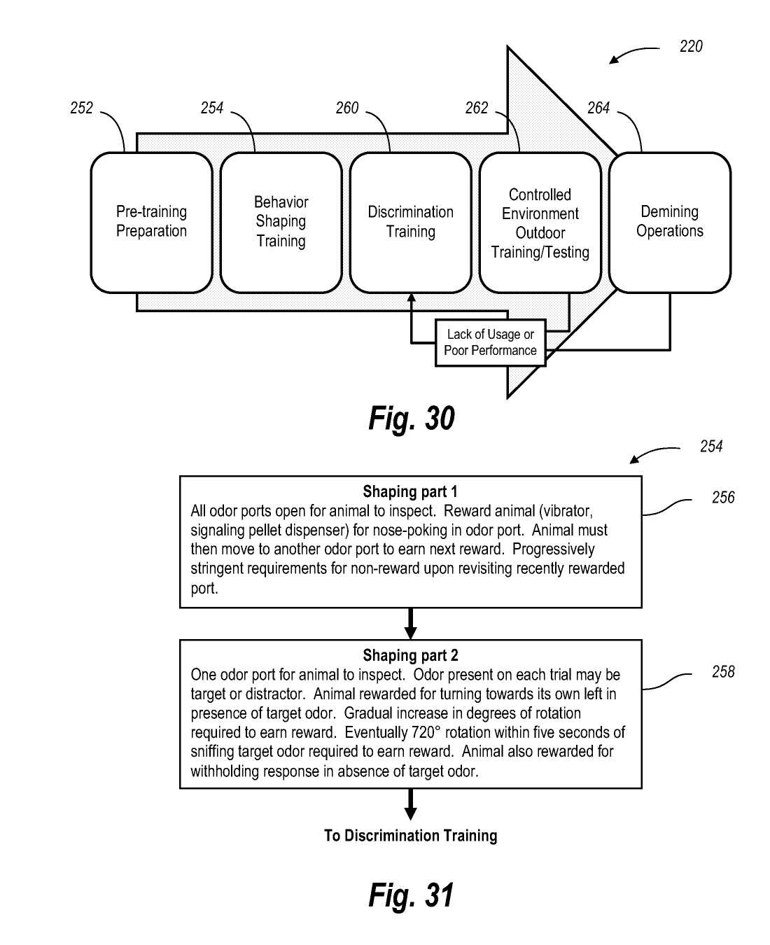

FIG. 30 below shows a training progression sequence 250 which can be performed to develop an animal for successful demining operations.

The sequence begins with a pre-training preparation phase 252, which ideally begins when animals are juveniles. In this phase the animal can be tagged with an RFID labeled ID tag so that there is a human visual and machine readable way to identify and keep track of the animal during its training. Also during this phase animals can be introduced to human interaction and habituated to humans by daily handling and hand-feeding indoors. This habituation process is usually practiced for 2 to 4 weeks, although that can vary by species or strain, with most rapid and long-lasting habituation typically found with younger animals. Towards the end of the habituation process the animal can be handled outdoors to get accustomed to the eventual working environment.

Next, the animal can be familiarized with the harness, animal training enclosure, and primary reward delivery in the bin. This can involve feeding the animal the primary reward (food pellets or sugar water) inside the animal training enclosure, familiarizing the animal with the primary reward delivery mechanism, and also screening out any animal that does not show motivation for the primary reward.

To complete the pre-training preparation phase 252, the vibrotactile stimulus in the animal harness can be introduced as the secondary reinforcer. This can be done by repeatedly pairing the vibrotactile stimulus with the primary reward for several sessions so that the animal comes to associate the vibrotactile stimulus with the primary reward. As the animal forms that association, the vibrotactile stimulus effectively becomes rewarding in and of itself, and thereafter can be delivered without the primary reward to reinforce appropriate responses.

After the pre-training preparation phase 252 is complete, the animal can be trained in the behavior shaping training phase 254. The purpose of the behavior shaping training is two-fold. First, the behavior shaping training stimulates the animal to be curious and explore the odor ports in the animal training enclosure, and learn that exploring the odor ports is essential for earning rewards. Second, the behavior shaping training gradually trains the animal to exhibit the highly-distinctive indicative response when the animal detects the target odor. Details of a protocol for the behavior shaping training phase 254 according to one embodiment are shown in FIG. 31. In this and the other training phases, success criteria can be set. For example, in one embodiment, the success criteria can be two consecutive sessions with greater than 99% hits in the presence of targets and less than 1% false positive response to distracters.

Briefly, in the first part 256 of the behavior shaping training phase 254, the animal is first rewarded (by stimulation of the vibro stimulus, which signals delivery of the food reward) for nose-poking in the open odor ports. As shaping continues, the animal learns that it must explore each port and is not rewarded for revisiting a port until visiting the other ports. This trains the animal to habitually visit all the ports. Once this behavior is established, the animal can be shaped to perform the indicative response (e.g., a circling behavior).

In the second part 258 of the behavior shaping training phase 254, a target odor is sometimes present in the odor ports. The system monitors the animal's position and movements via the electronic compass or accelerometer in the harness, as discussed above. In one embodiment, upon nose-poking into an odor port with the target present, the animal is immediately rewarded if the animal withdraws its head towards the left, but not if the animal withdraws its head towards the right.

Using principles of operant conditioning, as the animal increases the tendency to move to the left, the response requirement is made more stringent. For example, the animal can then be rewarded only if the animal withdraws to the left moving in at least a 20° arc, then only for moving 40°, and so on. Eventually, in order to obtain a reward, the animal may have to complete a large rotation, such as 360°, 540°, 720°, or other counterclockwise rotation upon smelling the target odor. Of course, the animal may be shaped to alternatively rotate clockwise instead. Furthermore, rotation is only one type of action that the animal can be shaped to perform. The animal may be shaped to alternatively perform other types of actions using the same shaping principles discussed above, as long as those actions are unique and not likely to be performed by the animal without shaping.

The next phase in the training progression sequence is the discrimination training phase 260. The purpose of the discrimination training phase is to present the animal with a progressively more difficult series of trials where the animal must detect the presence or absence of the target odor when the target odor is presented within an array of multiple non-target distracters. In this phase, animals can be trained in once- or twice-daily sessions, with each session consisting of up to several dozen unique trials and lasting approximately 30-45 minutes in one embodiment.

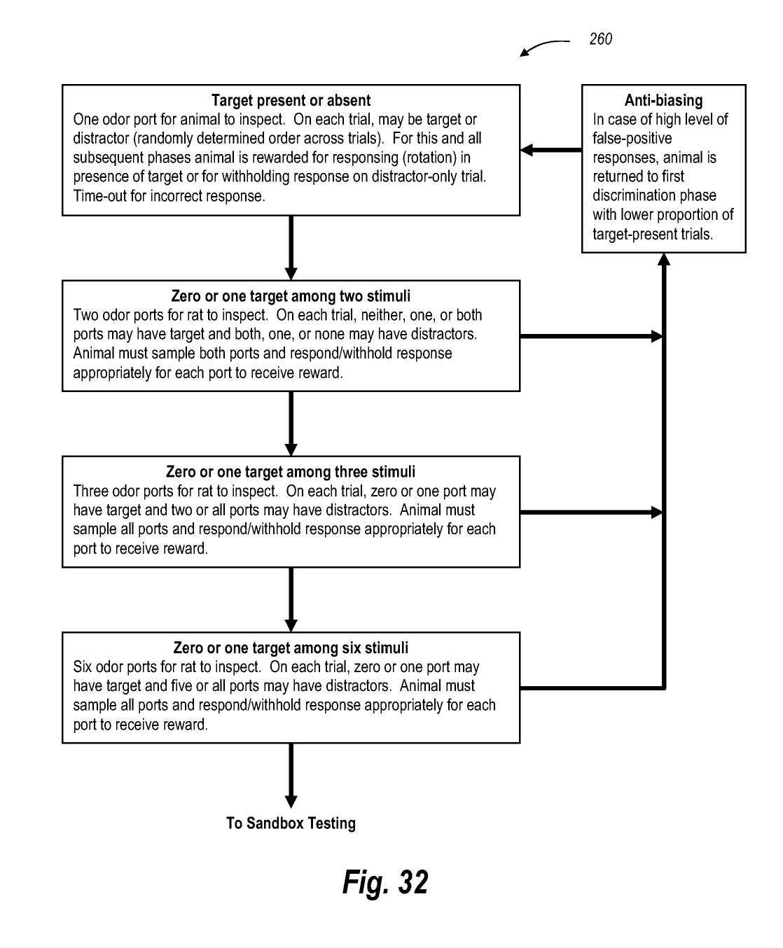

Details of a protocol for the discrimination training phase 260 according to one embodiment are shown in FIG. 32. As indicated, the simplest trial the animal must solve is to inspect a single odor canister at a time, and respond by performing the unique action, e.g., circling, if the odor is the target odor and withhold responding if the target odor is absent. At each stage of training, the problem can be made more difficult across sessions by using progressively weaker concentrations of the target odor in the target odor canisters, and/or by using mixed target/distracter canisters, and/or by increasing the number of distracter canisters presented on each trial. When an animal reliably demonstrates acceptable accuracy at one type of problem, the animal can move to the next stage, as depicted in FIG. 32.

Throughout discrimination training, responses on each trial can be scored as hits, misses, false alarms, and correct rejections, and performance can be analyzed using principles of Signal Detection Theory. For each animal this yields a measure of sensitivity (d′) representing the ability to accurately discriminate the target from noise and a measure of bias representing the general tendency to either respond or not respond under uncertainty. These metrics can be used to determine each individual's progress through the training, and to modify the training parameters as needed.

After successful completion of the discrimination training phase 260, the animal can be moved to the controlled environment training phase or “Sandbox” Testing. At this point in the training the animal has been engaged in indoor detection trials inside the animal training enclosure. The animal is now ready to be introduced to the outdoor conditions of the demining mission.

In the terminology of learning theory, it is desirable that the performance trained in the animal training enclosure ‘generalizes’ into novel environments, and sandbox testing can be used to verify whether this has occurred. Target odors can be buried in known locations within a test grid to see how the animal performs with the added distractions of the environment. This imposes the new requirement that animals explore the entire test grid systematically, rather than confining the search locally as is done in the animal training enclosure. Because targets are in known locations and the animal's movements are monitored by the system, the secondary reward can still be delivered for appropriate responses as in the animal training enclosure.

This phase of training provides the trained animals a transition from the RAT System to actual field work. In addition, this phase allows the trainer to verify that the particular animal is indeed ready for the field work by the animal's ability to find targets in a more realistic environment. The general idea is to plant both target and non-target canisters in a known location buried below the soil surface, and see if the trained animal locates and performs the circling behavior for the target odor. The results of sandbox testing can determine if the animal should return to the animal training enclosure for additional training or proceed to actual field testing.

Once the animal successfully completes the environmental training phase 262 the animal is ready for demining accreditation tests leading to demining operations 264. During demining operations 264, the animal is allowed to roam over a predetermined area that is suspected of containing mines. To accomplish this, a wire or the like can be extended between poles or stakes positioned on either side of a minefield. The animal can be tethered to the wire so that the animal is free to move along the wire between the end poles and have some lateral leeway perpendicular to the wire. Of course, other manners of tethering the animal or otherwise allowing the animal to roam over the predetermined area can also be used.

As the animal roams over the predetermined area, if the animal detects the odor representative of a mine the animal performs the learned behavior, such as the rotation discussed above. The user can mark the spot on a representative map to keep track of the detected mine. In one embodiment, a GPS tracker can be included in the animal harness assembly and the location of the animal can be automatically determined by the electronic system controller when the animal performs the learned behavior. In one embodiment, discussed above, the animal can carry a marker delivery apparatus that drops a marker substance, such as brightly colored ink, powder, or the like, that is dropped onto the ground when the animal performs the learned behavior.

If desired, more than one animal can be allowed to roam over the predetermined area at the same time. This can lessen the amount of time it may take to cover the predetermined area and may lead to more accurate determinations as the various portions of the predetermined area may be covered by more than one animal. In one embodiment, this is done by using a plurality of wires extending between corresponding poles or stakes on either side of the minefield. The wires can be positioned to be parallel to each other for systematic coverage of the mine field, if desired.

In one embodiment, the small animals trained according to the methods discussed herein can be used in conjunction with trained dogs or other approaches to provide overlapping levels of coverage for the predetermined areas. This can increase the probability that all mines in the minefield are found.

All of the above phases of training and demining operations have been designed to be able to be performed by an untrained person using local animals. As such, the RAT System can be shipped to any location in the world for local untrained people to use to train animals indigenous to the particular location. This can dramatically increase the ability to demine affected areas of the world. As discussed above, portions of the RAT System, such as the canisters and the animal harness assemblies can be stored within the ruggedized housing of the system controller assembly and shipped therewith.

To aid the untrained person (the “trainer”) to be able to train animals using the RAT System, a graphical user interface (GUI) can be used in conjunction with inputs from the person. For example, one exemplary method of performing a training session using the GUI will now be given. The GUI can be displayed on the user display and the trainer can input responses using a touch screen or mouse or other type of input device.

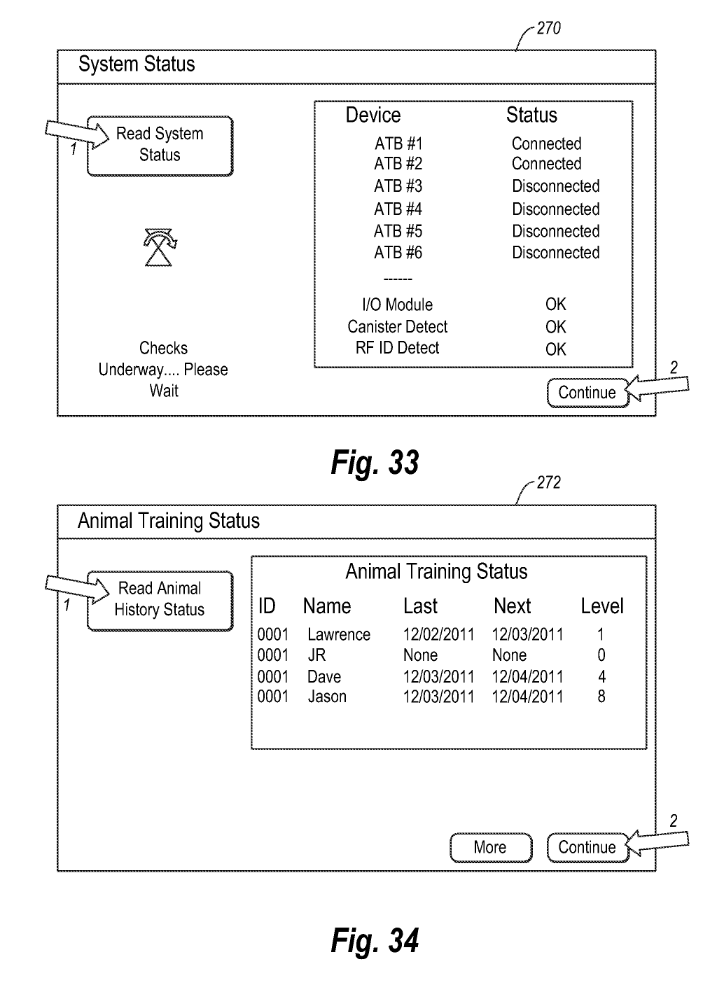

In the example GUI, the trainer is presented with the System Status window 270, shown in FIG. 33. The purpose of this window is to verify that the system controller assembly and animal training enclosure have been connected properly and that all the system I/O components are reporting valid operating condition. The trainer can select the “Read System Status” button to initiate the system status test. Once the status check is complete the results are posted in the right hand portion of the window, as shown. If the results show a “failed” result, the system controller can provide troubleshooting tips. The trainer can select the “Continue” button, when ready, to proceed to the Animal Training Status window 272, shown in FIG. 34.

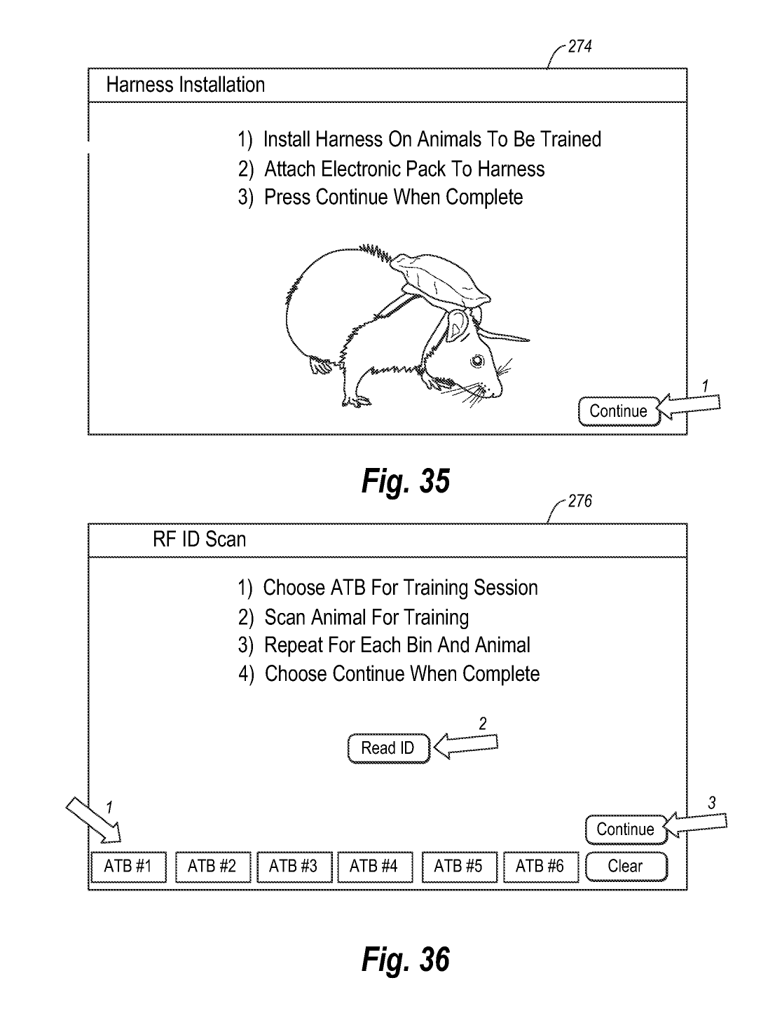

The purpose of the Animal Training Status window 272 is to retrieve animal training history data from the database stored on the system controller. This indicates to the trainer which animal is due for training. The trainer can select the “Read Animal History Status” button to initiate retrieval of the animal training history. The results are posted in the right hand portion of the window, as shown. Exemplary information that can be displayed include the ID number of the animal, which can be either tattooed or ear tagged upon the animal, any nicknames for the animal, the last training session date, the next date for which training is scheduled, the training level the animal has achieved, etc. The trainer can select “More” if additional animal history is needed or “Continue” if the trainer has the information needed to begin the training session. This will cause the Harness Installation window 274, shown in FIG. 35, to appear.

The purpose of the Harness Installation window 274 is to direct the trainer to install the harness on the animal. Toward that end, the Harness Installation window includes detailed instructions on installation of the harness. Once installation of the harness has been completed, the trainer can select the “Continue” button when harness installation is complete to continue to the RF/ID Scan window 276, shown in FIG. 36.

The purpose of the RF/ID Scan window 276 is to determine the particular animal being trained and to thereby determine the training protocol that will be used for, since each animal is on its own unique training path. The trainer first selects the animal training enclosure that is to be used for the training session by using the buttons located in the bottom portion of the window. In the depicted embodiment the trainer can select ATBs #1 through #6, although more or less options may be used depending on the number of ATBs available. When an animal training enclosure is selected the corresponding animal training enclosure button can be reverse highlighted or otherwise visually changed to reflect the selection.

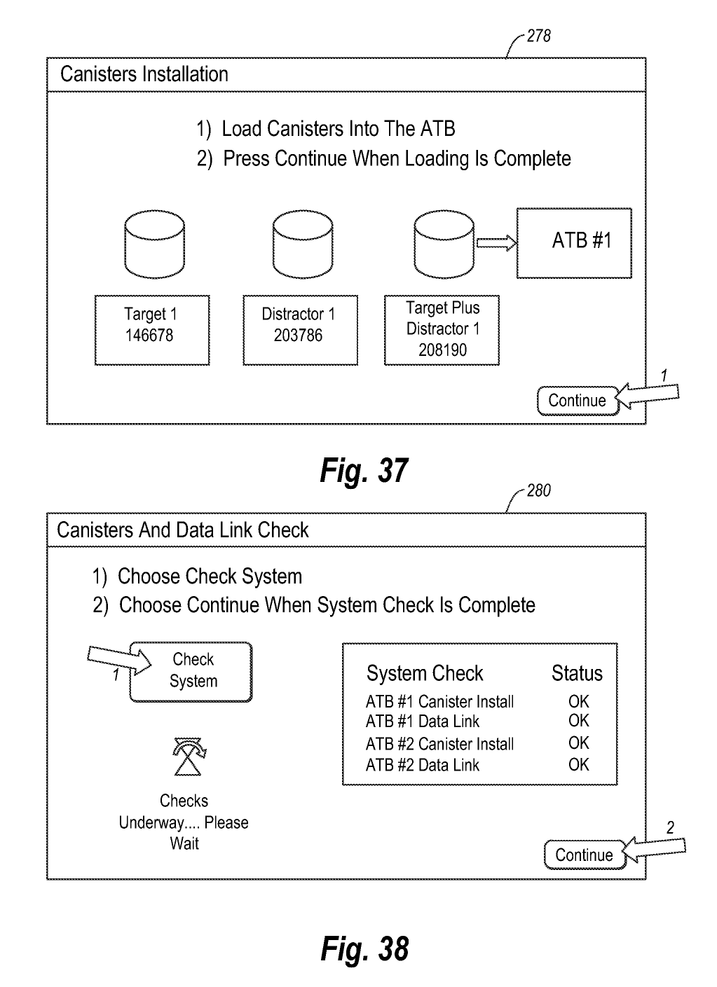

The trainer can select the “Read ID” button to initiate the system to scan the embedded RF/ID tag located in or on the animal. The animal can be placed within the selected animal training enclosure before or after the RF/ID tag has been scanned. If multiple animal training enclosures are in use, the trainer can repeat the above process as many times as necessary by selecting another available animal training enclosure, scanning the embedded RF/ID tag of the appropriate animal, and placing the animal in the corresponding animal training enclosure. This process can be performed for up to the number of training bins to be used. When all of the animals to be tested have been positioned within the corresponding ATBs, the trainer can select the “Continue” button to continue to the Canister Installation window 278, shown in FIG. 37. If the trainer inadvertently places the wrong animal in a bin, the “Clear” button can allow the user to reset the animal/training enclosure pairing.

The purpose of the Canister Installation window 278 is to guide the trainer in loading specific odor stimuli canisters into the animal training enclosure, dependent on the training protocol to be used for the animal. The trainer can be shown from 1 to x number of canisters, where x=the total number of canister slots available. In one embodiment, discussed above, there are a total of six available canisters (i.e., x=6). The canisters can be color coded and have UPC bar code stickers for aid in identification. The trainer can load the canisters in the manner shown in the window. If more than one animal training enclosure is being used, selection of the “Continue” button can show what canisters need to be loaded for the next used animal training enclosure. This process can be repeated until all training enclosures are loaded with canisters. Once the loading process is complete, the user can select the “Continue” button to proceed to the Canisters and Data Link Check window 280, shown in FIG. 38.

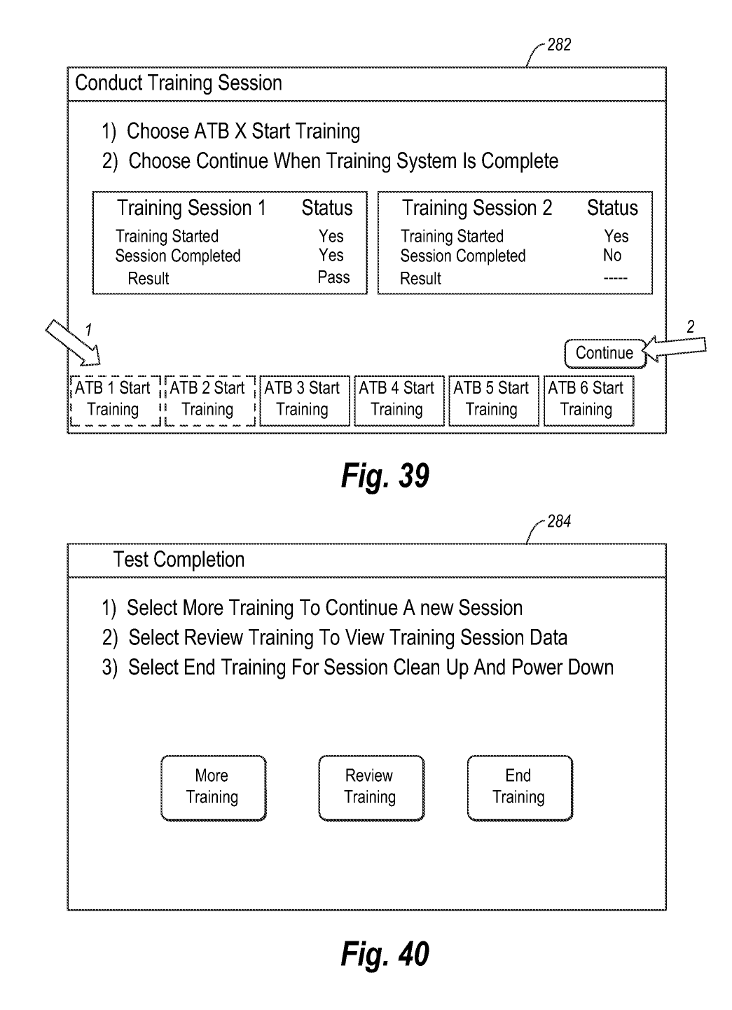

The purpose of the Canister and Data Link Check window 280 is to verify that i) the trainer has loaded the correct canisters into the animal training enclosure, and ii) the wireless connection between the system controller assembly and the wireless harness has been established. The trainer can select the “Check System” button, which causes the system to verify proper canister loading and wireless data link communications. The results of this check are displayed on the right hand portion of the window, as shown. If any canister or data link check returns a failed state, troubleshooting information can be provided, for example, in a pop up window. Once system checks have been completed and passed, then the user can select the “Continue” to continue to the Conduct Training Session window 282, shown in FIG. 39.

The purpose of the Conduct Training Session window 282 is to allow the trainer to initiate a training session for each animal training enclosure in use. The trainer can select the “Start Training” button corresponding to the desired animal training enclosure to initiate a training session in the selected animal training enclosure. Once the training has been initiated the corresponding “Start Training” button can be reverse highlighted or otherwise modified on the screen to show the trainer that training has commenced. A subwindow corresponding to the initiated training session appears and provides training progress information during the course of the training session. If multiple ATBs are being used, the trainer can select another “Start Training” button corresponding to another animal training enclosure to initiate training the corresponding animal training enclosure. This causes another sub-window to appear, providing training progress information for that specific animal training enclosure. This can be repeated for each animal training enclosure that is being used to conduct training. When a training session is complete, the subwindow reflects the completion. Once the training sessions are completed, then the user can select the “Continue” button to continue to the Test Completion window 284, shown in FIG. 40.

The purpose of the Test Completion window 284 is to allow the trainer to conduct additional rounds of training sessions, find out specifics of the training sessions just completed, or end training for the day. Accordingly, the trainer is presented with three button options: “More Training,” “Review Training,” and “End Training”

Selecting “More Training” leads to a regular or pop up window that instructs the trainer to put away the animals, canisters, etc. that were used in the just completed training and places the application program back to the start of a training session (e.g., to the Animal Training Status window).

Selecting “Review Training” leads to another window or windows that allow the trainer to access detailed data about the current training session, and past training sessions. When complete with reviewing, the trainer is returned to the Test Completion window 284 to begin more training or end training

Selecting “End Training” leads to a regular or pop up window that provides the trainer with instructions to return the animals, canisters, etc. that were used in the just completed training to the appropriate storage areas. The “End Training” selection also can instruct the trainer to re-charge the internal batteries, and provide details of the re-charging process.

The above is but one embodiment of a GUI that can be used with the untrained trainer. Other GUIs can be used instead of or in conjunction with the GUI presented herein.

As discussed above, various benefits over the art can be realized by embodiments of the present invention. These include, but are not limited to:
animals can be trained to detect landmines by non-experts;
once trained, the animals can be used to detect landmines by non-experts;
animals can be trained at the landmine site;
animals indigenous to a landmine area can be used;
training kits can be shipped quickly to anywhere in the world they are needed, unaccompanied by an expert;
the training kits can be ruggedized for use anywhere in the world; and
multiple animals can be trained concurrently using a single electronic system controller.

The above list of benefits is by no means exhaustive. Other benefits are also realized as discussed above and as will become apparent by use of the various embodiments.

As a result of the above benefits, many global benefits can be realized. For example, because embodiments of the present invention can be used by non-experts to train animals indigenous to a minefield area, those embodiments can be shipped to the particular areas where they are needed. Furthermore, because non-experts can perform the training and demining, expert trainers do not need to accompany and use the systems, thereby reducing cost. This also leads to better availability, since the pool of “non-experts” is virtually limitless.

In light of the above, it is conceivable that a large number of RAT Systems can be manufactured and shipped to locations throughout the world for local people to use to train and then use indigenous animals to demine minefields, thereby dramatically reducing the time and cost involved if conventional systems were used. This will help to remove the extremely dangerous minefields in a much shorter time, thereby allowing the local peoples to use the demined areas and not worry about buried mines.

Listed below are some embodiments of the invention. However, the list below is not inclusive; other embodiments are also possible.

A system for training animals, the system comprising: an animal training enclosure, comprising: a housing bounding a training chamber, the housing comprising a floor having a plurality of ports that communicate with the training chamber; a stimuli delivery assembly disposed below the floor, the stimuli delivery assembly comprising: a positioner that is movable between a first position, in which a predetermined portion of the positioner is aligned with a first one of the ports, and a second position, in which the predetermined portion of the positioner is aligned with a second one of the ports; an actuator that moves the positioner between the first and second positions; and a container configured to be filled with a material that provides a stimulus, the container being securable on the predetermined portion of the positioner such that the container is aligned with the first and second ports, respectively, when the positioner is positioned in the first and second positions; and a primary reinforcement apparatus that communicates with the training chamber so as to selectively provide a primary animal reinforcement to the training chamber; an animal harness assembly configured to be mounted on an animal so as to monitor the actions of the animal when the animal is positioned within the training chamber; and a system controller assembly that electronically communicates with the animal training enclosure and the animal harness assembly.

In one embodiment, the ports are spaced apart from each other about a radius having a center axis.

In one embodiment, the actuator rotates the positioner about the center axis.

In one embodiment, the stimulus is a predetermined odor and the container is filled with a material that provides the predetermined odor.

In one embodiment, the stimuli deliver assembly comprises one or more further containers securable to the positioner so as to be alignable with the ports.

In one embodiment, the primary reinforcement apparatus comprises a food dispenser and the primary animal reinforcement comprises food that is dispensed by the food dispenser when an animal performs a predetermined action within the training chamber.

In one embodiment, the animal harness assembly comprises: an orientation detector configured to determine the orientation of an animal on which the animal harness assembly is mounted; a secondary reinforcement apparatus configured to selectively provide a secondary reinforcement to the animal; and a wireless interface that wirelessly communicates with the system controller assembly.

In one embodiment, the orientation detector comprises an electronic compass.

In one embodiment, the secondary reinforcement apparatus comprises a vibrotactile apparatus and the secondary reinforcement comprises a vibration provided by the vibrotactile apparatus when the animal performs a predetermined action within the training chamber.

In one embodiment, the wireless interface comprises a Bluetooth interface.

In one embodiment, the animal harness assembly comprises a marker delivery apparatus configured to deliver a marker to mark the location of a mine when an animal wearing the animal harness assembly detects a mine.

In one embodiment, the system controller assembly comprises: a system controller; a user interface assembly through which the system controller electronically communicates with the animal training enclosure; and a wireless interface through which the system controller electronically communicates with the animal harness assembly.

In one embodiment, the system controller comprises a laptop computer.

In one embodiment, the wireless interface comprises a Bluetooth interface.

In one embodiment, the system controller further comprises a ruggedized shipping container in which the system controller, the user interface assembly, and the wireless interface are housed.

In one embodiment, the system controller assembly electronically receives information from the animal harness assembly corresponding to an orientation of the animal.

In one embodiment, the system controller assembly communicates wirelessly with the animal harness assembly.

A system for training animals, the system comprising: a plurality of animal training enclosures, each comprising: a housing bounding a training chamber, the housing comprising a floor having a plurality of ports that communicate with the training chamber; a stimuli delivery assembly disposed below the floor, the stimuli delivery assembly comprising: a positioner that is movable between a first position, in which a portion of the positioner is aligned with a first one of the ports, and a second position, in which the portion of the positioner is aligned with a second one of the ports; an actuator that moves the positioner between the first and second positions; and a container configured to be filled with a material that provides a stimulus, the container being securable on the predetermined portion of the positioner such that the container is aligned with the first and second ports, respectively, when the positioner is positioned in the first and second positions; and a primary reinforcement apparatus that communicates with the training chamber so as to selectively provide a primary animal reinforcement to the training chamber; a plurality of animal harness assemblies, each configured to be mounted on an animal so as to monitor the actions of the animal when the animal is positioned within one of the training chambers; and a system controller assembly that electronically communicates with the plurality of animal training enclosures and the plurality of animal harness assemblies.

In one embodiment, the ports of each animal training enclosure are spaced apart from each other about a radius having a center axis.

In one embodiment, for each animal training enclosure, the actuator rotates the positioner about the center axis.

In one embodiment, for each animal training enclosure, the stimulus is a predetermined odor and the container is filled with a material that provides the predetermined odor.

In one embodiment, for each animal training enclosure, the stimuli deliver assembly comprises one or more further containers securable to the positioner so as to be alignable with the ports.

In one embodiment, for each animal training enclosure, the primary reinforcement apparatus comprises a food dispenser and the primary animal reinforcement comprises food that is dispensed by the food dispenser when an animal performs a predetermined action within the training chamber.

In one embodiment, each animal harness assembly comprises: an orientation detector configured to determine the orientation of an animal on which the animal harness assembly is mounted; a secondary reinforcement apparatus configured to selectively provide a secondary reinforcement to the animal; and a wireless interface that wirelessly communicates with the system controller assembly.

In one embodiment, the orientation detector comprises an electronic compass.

In one embodiment, the secondary reinforcement apparatus comprises a vibrotactile apparatus and the secondary reinforcement comprises a vibration provided by the vibrotactile apparatus when the animal performs a predetermined action within the training chamber.

In one embodiment, the wireless interface comprises a Bluetooth interface.

In one embodiment, each animal harness assembly comprises a marker delivery apparatus configured to deliver a marker to mark the location of a mine when an animal wearing the animal harness assembly detects a mine.

In one embodiment, the system controller assembly comprises: a system controller; a user interface assembly through which the system controller electronically communicates with the animal training enclosures; and a wireless interface through which the system controller electronically communicates with the animal harness assemblies.

In one embodiment, the system controller comprises a laptop computer.

In one embodiment, the wireless interface comprises a Bluetooth interface.

In one embodiment, the system controller further comprises a ruggedized shipping container in which the system controller, the user interface assembly, and the wireless interface are housed.

In one embodiment, the system controller assembly electronically receives information from each of the animal harness assemblies corresponding to an orientation of the animal on which the corresponding animal harness assembly is mounted.

In one embodiment, the system controller assembly communicates wirelessly with the animal harness assemblies.

A kit for training animals, the kit comprising: an animal training enclosure, comprising: a housing bounding a training chamber, the housing comprising a floor having a plurality of ports that communicate with the training chamber; a stimuli delivery assembly disposed below the floor, the stimuli delivery assembly comprising: a positioner having a plurality of container ports, each container port being positioned on the positioner so as to align with each of the floor ports as the positioner is moved; and an actuator that moves the positioner; and a primary reinforcement apparatus that communicates with the training chamber so as to selectively provide a primary animal reinforcement to the training chamber; a plurality of containers, each configured to be filled with a material that provides an odor stimulus that can include a target odor, a distracter odor, or a combination of both, each container being receivable within any of the container ports of the positioner such that different combinations of containers can be used for different training sessions; a plurality of animal harness assemblies, each configured to be mounted on an animal when the animal is positioned within the training chamber; and a system controller assembly that electronically communicates with the animal training enclosure and the plurality of animal harness assemblies so as to monitor animals and control training when the animals are within the training chamber.

In one embodiment, the kit further comprises a ruggedized case in which the system controller assembly is housed.

In one embodiment, the ruggedized case includes compartments in which the plurality of containers and the plurality of animal harness assemblies can be stored for shipping.

A method of training an animal, the method comprising: determining when an animal exhibits a specific behavior in response to a predetermined stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on a harness mounted on the animal.

In one embodiment, determining when the animal exhibits the specific behavior in response to the predetermined stimulus is performed electronically.

In one embodiment, the specific behavior comprises a rotation and wherein determining when the animal exhibits the rotation comprises electronically analyzing data from an electronic compass positioned on the harness mounted on the animal.

In one embodiment, providing a secondary reinforcement to the animal comprises activating a vibrotactile apparatus on the harness to vibrate the apparatus.

In one embodiment, the animal being trained is a rodent.

In one embodiment, the animal being trained is one of: a Norway rat, a domestic ferret, an Asian mongoose, and an African pouched rat.

In one embodiment, the predetermined stimulus is an odor.

In one embodiment, the odor is representative of unexploded landmines.

A method of concurrently training a plurality of animals, the method comprising: placing a plurality of animals in a plurality of animal training enclosures, a separate animal being placed in each training enclosure; and concurrently for each animal: monitoring the activity of the animal in the corresponding animal training enclosure; determining when the animal exhibits a specific behavior in response to a predetermined stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on a harness mounted on the animal.

In one embodiment, monitoring the activity of each animal occurs concurrently.

In one embodiment, determining when each of the animals exhibit the specific behavior in response to the predetermined stimulus is performed electronically.

In one embodiment, the specific behavior comprises a rotation and wherein determining when the animal exhibits the rotation comprises electronically analyzing data from an electronic compass positioned on the harness mounted on the animal.

In one embodiment, providing a secondary reinforcement to the animal comprises activating a vibrotactile apparatus on the harness to vibrate the apparatus.

In one embodiment, the animals being trained are rodents.

In one embodiment, the animals being trained comprise one or more of the following: Norway rats, domestic ferrets, Asian mongooses, and African pouched rats.

In one embodiment, the predetermined stimulus is an odor.

In one embodiment, the odor is representative of unexploded landmines.

A method of detecting an unexploded landmine, the method comprising: obtaining an animal indigenous to an area where unexploded landmines are suspected to be located; training the animal, by an electronic system controller, to exhibit a specific behavior when the animal detects an odor representative of unexploded landmines; and using the trained animal to detect an unexploded landmine by the animal performing the specific behavior at the area where unexploded landmines are suspected to be located.

In one embodiment, training the animal comprises, by the electronic system controller: monitoring the activity of the animal in an animal training enclosure; determining when the animal performs the specific behavior in response to a predetermined stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on a harness mounted on the animal.

In one embodiment, providing the secondary reinforcement to the animal comprises activating a vibrotactile apparatus on the harness to vibrate the apparatus.

In one embodiment, the specific behavior comprises a rotation and wherein determining when the animal performs the rotation comprises electronically analyzing data from an electronic compass positioned on the harness mounted on the animal.

In one embodiment, the animal being trained is a rodent.

In one embodiment, the animal being trained is one of: a Norway rat, a domestic ferret, an Asian mongoose, and an African pouched rat.

In one embodiment, using the trained animal to detect the unexploded landmine comprises: tethering the animal near the location where unexploded landmines are suspected; allowing the animal to investigate the location; and determining that an unexploded landmine is present by the animal performing the specific behavior learned by the animal during training

In one embodiment, using the trained animal to detect unexploded landmines further comprises the animal delivering a marker to the location of an unexploded landmine.

A method of demining a minefield, the method comprising: receiving an animal training kit, the kit comprising: an animal training enclosure, comprising: a housing bounding a training chamber, the housing comprising a floor having a plurality of ports that communicate with the training chamber; a stimuli delivery assembly disposed below the floor, the stimuli delivery assembly comprising: a positioner having a plurality of container ports, each container port being positioned on the positioner so as to align with each of the floor ports as the positioner is moved; and an actuator that moves the positioner; and a primary reinforcement apparatus that communicates with the training chamber so as to selectively provide a primary animal reinforcement to the training chamber; a plurality of containers, each configured to be filled with a material that provides an odor stimulus that can include a target odor, a distracter odor, or a combination of both, each container being receivable within any of the container ports of the positioner such that different combinations of containers can be used for different training sessions; a plurality of animal harness assemblies, each configured to be mounted on an animal when the animal is positioned within the training chamber; and a system controller assembly that electronically communicates with the plurality of animal training enclosures and the plurality of animal harness assemblies so as to monitor the animal and control training when the animal is within the training chamber; obtaining an animal indigenous to the minefield area; training the animal, using the animal training kit, to exhibit a specific behavior when a target stimulus indicative of a mine has been detected; placing the trained animal in the minefield and determining a location of an unexploded mine by detecting when the animal performs the specific behavior.

In one embodiment, the method further comprises removing or detonating the detected mine.

In one embodiment, training the animal comprises, by the electronic system controller assembly: monitoring the activity of the animal in the animal training enclosure; determining when the animal performs the specific behavior in response to the target stimulus; providing a secondary reinforcement to the animal when the animal performs the specific behavior; and providing a primary reinforcement to the animal after the secondary reinforcement is provided so that the animal associates the secondary reinforcement with the primary reinforcement, the secondary reinforcement being positioned on the animal harness assembly mounted on the animal.

In one embodiment, providing the secondary reinforcement to the animal comprises activating a vibrotactile apparatus of the animal harness assembly to vibrate the apparatus.

In one embodiment, the specific behavior comprises a rotation and wherein determining when the animal performs the rotation comprises electronically analyzing data from an electronic compass of the animal harness assembly mounted on the animal.

In one embodiment, the animal being trained is a rodent.

In one embodiment, the animal being trained is one of: a Norway rat, a domestic ferret, an Asian mongoose, and an African pouched rat.

In one embodiment, placing the trained animal in the minefield and determining the location of the unexploded mine comprises: tethering the animal near the location where unexploded mines are suspected; allowing the animal to investigate the location; and determining that an unexploded mine is present by the animal performing the specific behavior learned by the animal during training

In one embodiment, the method further comprises the animal delivering a marker to the location of the unexploded landmine.

The present invention may be embodied in other specific forms without departing from its spirit or essential characteristics. Accordingly, the described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A system for training animals, the system comprising:
an animal training enclosure, comprising:
a housing bounding a training chamber, the housing comprising a floor having a plurality of ports that communicate with the training chamber;
a stimuli delivery assembly disposed below the floor, the stimuli delivery assembly comprising:
a positioner that is movable between a first position, in which a predetermined portion of the positioner is aligned with a first one of the ports, and a second position, in which the predetermined portion of the positioner is aligned with a second one of the ports;
an actuator that moves the positioner between the first and second positions; and
a container configured to be filled with a material that provides a stimulus, the container being securable on the predetermined portion of the positioner such that the container is aligned with the first and second ports, respectively, when the positioner is positioned in the first and second positions; and
a primary reinforcement apparatus that communicates with the training chamber so as to selectively provide a primary animal reinforcement to the training chamber;
an animal harness assembly configured to be mounted on an animal so as to monitor the actions of the animal when the animal is positioned within the training chamber.
a system controller assembly that electronically communicates with the animal training enclosure and the animal harness assembly.

2. The system as recited in claim 1, wherein the ports are spaced apart from each other about a radius having a center axis.

3. The system as recited in claim 2, wherein the actuator rotates the positioner about the center axis.

4. The system as recited in claim 1, wherein the stimulus is a predetermined odor and the container is filled with a material that provides the predetermined odor.

5. The system as recited in claim 1, wherein the stimuli deliver assembly comprises one or more further containers securable to the positioner so as to be alignable with the ports.

6. The system as recited in claim 1, wherein the primary reinforcement apparatus comprises a food dispenser and the primary animal reinforcement comprises food that is dispensed by the food dispenser when an animal performs a predetermined action within the training chamber.

7. The system as recited in claim 1, wherein the animal harness assembly comprises:
an orientation detector configured to determine the orientation of an animal on which the animal harness assembly is mounted;
a secondary reinforcement apparatus configured to selectively provide a secondary reinforcement to the animal; and
a wireless interface that wirelessly communicates with the system controller assembly.

8. (canceled)

9. The system as recited in claim 7, wherein the secondary reinforcement apparatus comprises a vibrotactile apparatus and the secondary reinforcement comprises a vibration provided by the vibrotactile apparatus when the animal performs a predetermined action within the training chamber.

10-11. (canceled)

12. The system as recited in claim 1, wherein the system controller assembly comprises:
a system controller;
a user interface assembly through which the system controller electronically communicates with the animal training enclosure; and
a wireless interface through which the system controller electronically communicates with the animal harness assembly.

13-15. (canceled)

16. The system as recited in claim 1, wherein the system controller assembly electronically receives information from the animal harness assembly corresponding to an orientation of the animal.

17. The system as recited in claim 1, wherein the system controller assembly communicates wirelessly with the animal harness assembly.

18-34. (canceled)

35. A kit for training animals, the kit comprising:
an animal training enclosure, comprising:
a housing bounding a training chamber, the housing comprising a floor having a plurality of ports that communicate with the training chamber;
a stimuli delivery assembly disposed below the floor, the stimuli delivery assembly comprising:
a positioner having a plurality of container ports, each container port being positioned on the positioner so as to align with each of the floor ports as the positioner is moved; and
an actuator that moves the positioner; and
a primary reinforcement apparatus that communicates with the training chamber so as to selectively provide a primary animal reinforcement to the training chamber;
a plurality of containers, each configured to be filled with a material that provides an odor stimulus that can include a target odor, a distracter odor, or a combination of both, each container being receivable within any of the container ports of the positioner such that different combinations of containers can be used for different training sessions;
a plurality of animal harness assemblies, each configured to be mounted on an animal when the animal is positioned within the training chamber; and
a system controller assembly that electronically communicates with the animal training enclosure and the plurality of animal harness assemblies so as to monitor animals and control training when the animals are within the training chamber.

36. The kit as recited in claim 35, further comprising a ruggedized case in which the system controller assembly is housed.

37. The system as recited in claim 36, wherein the ruggedized case includes compartments in which the plurality of containers and the plurality of animal harness assemblies can be stored for shipping.

38. A method of training an animal, the method comprising:
determining when an animal exhibits a specific behavior in response to a predetermined stimulus;
providing a secondary reinforcement to the animal when the animal performs the specific behavior; and
providing a primary reinforcement to the animal after the secondary reinforcement is provided so that the animal associates the secondary reinforcement with the primary reinforcement, the secondary reinforcement being positioned on a harness mounted on the animal.

39. The method as recited in claim 38, wherein determining when the animal exhibits the specific behavior in response to the predetermined stimulus is performed electronically.

40. The method as recited in claim 38, wherein the specific behavior comprises a rotation and wherein determining when the animal exhibits the rotation comprises electronically analyzing data from an electronic compass positioned on the harness mounted on the animal.

41. The method as recited in claim 38, wherein providing a secondary reinforcement to the animal comprises activating a vibrotactile apparatus on the harness to vibrate the apparatus.

42. The method as recited in claim 38, wherein the animal being trained is a rodent.

43. (canceled)

44. The method as recited in claim 38, wherein the predetermined stimulus is an odor.

45-71. (canceled)
